(19) United States
(12) Patent Application Publication
(10) Pub. No.: US 2020/0317829 A1
(43) Pub. Date: Oct. 8, 2020

(54) SOLID SUPPORT MATERIAL

(71) Applicant: SCG Chemicals Co., Ltd., Bangkok (TH)

(72) Inventors: Dermot O'Hare, Oxford (GB); Jean-Charles Buffet, Oxford (GB); Alexander Kilpatrick, Oxford (GB); Christopher Wright, Oxford (GB)

(21) Appl. No.: 16/758,288

(22) PCT Filed: Nov. 5, 2018
(86) PCT No.: PCT/GB2018/053205

§ 371 Date: Apr. 22, 2020

(30) Foreign Application Priority Data
Nov. 3, 2017 (GB) 1718279.1

(51) Int. Cl. C08F 4/659; C08F 4/642; C08F 4/6592; C08F 210/02

(52) U.S. Cl. CPC C08F 4/65916; C08F 4/6428; C08F 2410/01; C08F 4/65927; C08F 210/02; C08F 4/65925

(57) ABSTRACT

Solid support materials are described for use as supports for olefin polymerisation catalysts. Also described is a process for the preparation of the solid support materials and the use of the solid support materials as supports in olefin polymerisation reactions.

### INTRODUCTION

The present invention relates to a solid support material suitable for supporting an olefin polymerisation catalyst, as well as to processes for preparing the solid support material. More particularly, the present invention relates to a layered double hydroxide-methylaluminoxane-containing solid support material. The present invention also relates to catalytic compositions comprising the solid support material on top of which is supported an olefin polymerisation catalyst, as well as to an olefin polymerisation process employing the catalytic compositions.

### BACKGROUND OF THE INVENTION

It is well known that ethylene (and α-olefins in general) can be readily polymerised at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

Catalytic reactions involving Ziegler-Natta catalysts, in particular metallocene-based catalysts, have traditionally employed the catalyst in solution phase. However, this technique has a number of drawbacks, most notably the difficulty of effectively separating the catalyst from the reaction medium and then recycling it for further use.

Given the high value that industry places on polyethylene (as well as other polyolefins), there is a need for improved solid-phase support materials capable of effectively supporting metallocene-based Ziegler-Natta catalysts.

The present invention was devised with the foregoing in mind.

### SUMMARY OF THE INVENTION

According to a first aspect of the present invention there is provided a solid support material suitable for supporting an olefin polymerisation catalyst, the solid support material comprising:

a) a layered double hydroxide;

b) a methylaluminoxane associated with the layered double hydroxide; and

c) a compound or moiety having a structure according to formula (I) and/or (II) defined herein.

According to a second aspect of the present invention there is provided a process for the preparation of a solid support material according to the first aspect, the process comprising the steps of:

a) thermally treating a layered double hydroxide at a temperature of 100-500° C.;

b) in a suitable solvent, combining, in a single or multiple steps, the thermally-treated layered double hydroxide, a methylaluminoxane and a compound having a structure according to formula (I) and/or (II) defined herein; and
c) isolating the product resulting from step b).

According to a third aspect of the present invention there is provided a solid support material obtainable, obtained or directly obtained by a process according to the second aspect.

According to a fourth aspect of the present invention there is provided a catalytic composition comprising an olefin polymerisation catalyst supported on a solid support material according to the first or third aspect.

According to a fifth aspect of the present invention there is provided a process for the preparation of a catalytic composition according to the fourth aspect, the process comprising the steps of:

a) providing, in a suitable solvent, a solid support material according to the first or third aspect of the invention;

b) contacting the solid support material with an olefin polymerisation catalyst, and c) isolating the product resulting from step b).

According to a sixth aspect of the present invention there is provided a process for the preparation of a polyolefin, the process comprising the step of:

a) contacting olefin monomers with a catalytic composition according to the fourth aspect of the invention.

### DETAILED DESCRIPTION OF THE INVENTION

### Definitions

The term “alkyl” as used herein refers to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein refers to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 2, 3, 4, 5 or 6 carbon atoms. The term includes reference to alkynyl moieties containing 1, 2 or 3 carbon-carbon triple bonds (CEC). This term includes reference to groups such as ethynyl, propynyl, butynyl, pentynyl and hexynyl.

The term “alkoxy” as used herein refers to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “haloalkyl” as used herein refers to an alkyl group wherein at least one hydrogen has been substituted with a halo group selected from chloro, fluoro, bromo and iodo. Haloalkyl are typically, but not always, fluoroalkyls. This term includes reference to trifluoromethyl.

The terms “carbocyclyl”, “carbocyclic” and “carbocycle” as used herein refer to alicyclic moiety having 3, 4, 5, 6, 7 or 8 carbon atoms. The group may be a bridged or polycyclic ring system. More often carbocyclyl groups are monocyclic. This term includes reference to groups such as cyclopropyl, cyclobutyl, cyclopentyl, cyclohexyl, norbornyl, bicyclo[2.2.2]octyl and the like.

The terms “heterocyclyl”, “heterocyclic” and “heterocycle” as used herein refer to a saturated (e.g. heterocycloalkyl) or unsaturated (e.g. heteroaryl) heterocyclic ring moiety having from 3, 4, 5, 6, 7, 8, 9 or 10 ring atoms, at least one of which is selected from nitrogen, oxygen, phosphorus, silicon and sulphur. In particular, heterocyclyl includes a 3- to 10-membered ring or ring system and more particularly a 5- or 6-membered ring.

The terms “aryl” and “aromatic” as used herein refer to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The terms “heteroaryl” and “heteroaromatic” as used herein refers to an aromatic heterocyclic ring system having 5, 6, 7, 8, 9 or 10 ring atoms, at least one of which is selected from nitrogen, oxygen and sulphur. The group may be a polycyclic ring system, having two or more rings, at least one of which is aromatic, but is more often monocyclic. This term includes reference to groups such as pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl, pteridinyl and the like.

The term “halogen” or “halo” as used herein refer to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

Solid Support Material

The first aspect of the invention provides a solid support material suitable for supporting an olefin polymerisation catalyst, the solid support material comprising:
a) a layered double hydroxide;
b) a methylaluminoxane associated with the layered double hydroxide; and
c) a compound or moiety having a structure according to formula (I) shown below:

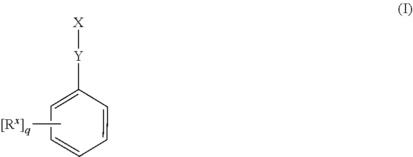

wherein
X represents a portion of the layered double hydroxide or the methylaluminoxane, or X is hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl;
Y is O, B(Q) or Al(Q)
   wherein Q is halo, hydroxyl or aryl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl, (2-4C)alkenyl, (2-4C)alkynyl and (1-4C)haloalkyl,
and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl, (2-4C)alkenyl, (2-4C)alkynyl and (1-4C)haloalkyl; and
q is 0 to 5.

Methylaluminoxane (MAO) modified layered double hydroxides (LDHMAO) are known to be useful as catalytic support materials in the heterogeneous slurry phase polymerisation of ethylene. Such materials are believed to include layered double hydroxide as a major component (by mass), on top of which is supported a quantity of MAO, formed by reaction with the former's surface hydroxyl groups. Owing to the utility of MAO as co-catalysts/activators in the polymerisation of olefins, such LDHMAO materials are particularly suitable in the heterogeneous slurry phase polymerisation of ethylene due to the fact that the material serves the dual purpose of being a support and a co-catalyst/activator.

Through extensive investigations, the present inventors have now devised the solid support materials of the invention, which are useful alternatives to LDHMAO support materials. In addition to comprising a quantity of LDH and MAO, the solid support materials further comprise an organic/organometallic modifying compound, or a moiety derived therefrom, having a structure according to formula (I). Without wishing to be bound by theory, it is believed that the aromatic nature of this modifying compound/moiety presents advantages when the solid support material is subsequently used to support olefin polymerisation catalysts such as metallocene-type Ziegler-Natta catalysts. In particular, it is believed that the presence of the aromatic modifying compound or moiety gives rise to favourable interactions (potentially π-π stacking) with aromatic groups present on the olefin polymerisation catalyst. It is believed that such interactions place the olefin polymerisation catalyst in an optimum position with respect to the MAO component of the solid support material for the latter to serve its purpose as co-catalyst/activator during olefin polymerisation reactions. It is also believed that groups present on the aromatic modifying compound/moiety (e.g. polar groups, such as C—F bonds) may stabilise (e.g. by weak ionic interaction) the cationic active species of the olefin polymerisation catalyst. Aside from these advantages, the solid support materials of the invention are weight-for-weight notably less expensive than LDHMAO, thereby presenting clear advantages for industrial scale-up applications.

The layered double hydroxide (LDH) is the major component (by mass) of the solid support material. LDHs will be familiar to one of ordinary skill in the art as being a class of ionic solids comprising layers of cationic metal hydroxides having anions intercalated in the gallery therebetween. It will be understood that the term “layered double hydroxide” as used herein encompasses thermally-treated derivatives thereof.

In an embodiment, the LDH comprises a first metal cation M selected from Mg²⁺, Zη²⁺, Fe²⁺, Ca²⁺, Ni²⁺, Co²⁺, Mn²⁺, Cu²⁺ and Li⁺. Suitably, the LDH comprises a first metal cation M selected from Mg²⁺, Zη²⁺, Fe²⁺, Ni²⁺, Co²⁺ and Cu²⁺. More suitably, the LDH comprises a first metal cation M selected from Mg²⁺, Zη²⁺ and Ni²⁺.

In an embodiment, the LDH comprises a second metal cation M′ selected from Al³⁺, Ga³⁺, Y³⁺, Iη³⁺, Fe³⁺, Co³⁺, Ni³⁺, Mn³⁺, Cr³⁺, Ti³⁺, V³⁺, La⁴⁺, Sn⁴⁺, Ti⁴⁺ and Zr⁴⁺. Suitably, the LDH comprises a second metal cation M′ selected from Al³⁺, Ti³⁺, Ti⁴⁺ and Zr⁴⁺. More suitably, the LDH comprises a second metal cation M′ that is Al³⁺.

In an embodiment, the cations M and M′ are such that the LDH is a Mg/Al, Ca/Al, Ni/Al, Cu/Al or a Zn/Al LDH. Suitably, the cations M and M′ are such that the LDH is a Mg/Al LDH.

In an embodiment, the LDH comprises at least one anion selected from hydroxide, carbonate, bicarbonate, hydrogenphosphate, dihydrogenphosphate, nitrite, borate, nitrate, phosphate, sulphate and bisulphate. Suitably, the LDH comprises at least one anion selected from carbonate, nitrate, nitrite and sulphate. More suitably, the LDH comprises at least one anion selected from carbonate and nitrate. Even more suitably, the LDH comprises at least one carbonate anion.

In a particularly suitable embodiment, the LDH is a Mg₃Al—CO₃ or a Mg₃Al—SO₄ LDH.

In a particularly suitable embodiment, the LDH is a magnesium aluminium carbonate LDH.

In an embodiment, the LDH has a composition according to formula (A) shown below:

[M^{z+}₁₋ₓM^{′y+}ₓ(OH)₂]^{a+}(Xⁿ⁻)ₘ.bH₂O.c(solvent) (A)

wherein

M is a charged metal cation;

M′ is a charged metal cation different from M;

z is 1 or 2;

y is 3 or 4;

0<x<0.9;

0<b≤10;

0≤c≤10

X is an anion;

n is the charge on anion X;

a is equal to z(1−x)+xy−2;

m≥a/n; and

the solvent is an organic solvent capable of hydrogen-bonding to water.

M and M′ may have any of the definitions discussed hereinbefore.

In an embodiment, when z is 2, M is Mg, Zn, Fe, Ca, or a mixture of two or more of these, or when z is 1, M is Li. Suitably, z is 2 and M is Ca, Mg, Zn or Fe. More suitably, z is 2 and M is Ca, Mg or Zn.

In an embodiment, when y is 3, M′ is Al, Fe, Ti, or a mixture thereof, or when y is 4, M′ is Ti. Suitably, y is 3. More suitably, y is 3 and M′ is Al.

In an embodiment, X is at least one anion selected from hydroxide, carbonate, bicarbonate, hydrogenphosphate, dihydrogenphosphate, nitrite, borate, nitrate, phosphate, sulphate and bisulphate. Suitably, X is at least one anion selected from carbonate, nitrate, nitrite and sulphate. More suitably, X is at least one anion selected from carbonate and nitrate.

In an embodiment, x has a value according to the expression 0.18<x<0.9. Suitably, x has a value according to the expression 0.18<x<0.5. More suitably, x has a value according to the expression 0.18<x<0.4.

The LDH may be one that has been treated, prior to drying, with an organic solvent capable of hydrogen-bonding to water. Without wishing to be bound by theory, the inventors have hypothesised that by treating, prior to drying, the LDH with an organic solvent having hydrogen bonding characteristics (e.g. as donor or acceptor), residual water present between the layers of the LDH or on its surface can be efficiently removed. The removal of this residual water greatly reduces the extent to which individual LDH particulates or crystallites aggregate through hydrogen-bonding of residual water present on their surfaces, thereby resulting in a finer, free-flowing LDH powder having high surface area. Such a treatment step may leave a residual quantity of organic solvent in the LDH composition. Therefore, for LDHs where 0<c≤10, such LDHs will be understood to have been treated, prior to drying, with an organic solvent capable of hydrogen-bonding to water.

A particularly suitable class of organic solvents capable of hydrogen-bonding to water are those that are miscible with water (i.e. aqueous miscible organic solvents, abbreviated herein to ‘AMO’). In an embodiment, the organic solvent capable of hydrogen-bonding to water is acetone or ethanol.

The structure and composition of MAO will be familiar to one of ordinary skill in the art. In particular, it will be understood MAO is an organoaluminium compound comprising a repeating moiety of formula (B) below:

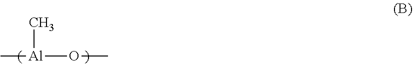

The MAO useful as part of the present invention is soluble in hydrocarbon solvents such as toluene and n-hexane.

Suitably, less than 20 wt % of the methyl groups present in the repeating moiety of formula (B) have been exchanged for a different alkyl group (e.g. iso-butyl or octyl). More suitably, less than 10 wt % of the methyl groups present in the repeating moiety of formula (B) have been exchanged for a different alkyl group. Even more suitably, less than 5 wt % of the methyl groups present in the repeating moiety of formula (B) have been exchanged for a different alkyl group. Yet more suitably, less than 1 wt % of the methyl groups present in the repeating moiety of formula (B) have been exchanged for a different alkyl group. Most suitably, all of the repeating moieties of MAO, unless modified by association with the LDH and/or compound/moiety of formula (I) and/or (II), have a structure according to formula (B).

The MAO is associated with the layered double hydroxide. Such association may arise as a result of one or more different interactions including ionic, covalent, hydrogen bonding and Van der Waals interactions. In an embodiment, at least a portion of the MAO is covalently bonded to the LDH via the latter's surface hydroxyl groups. It will be understood that when a portion of the MAO is covalently bonded to the surface of the LDH, the structure of that portion of MAO may differ from the repeating moiety of formula (B). Scheme 1 below provides a schematic representation of how MAO may be associated with the surface of the LDH:

Hence, the solid support material of the invention may comprise a portion of MAO comprising a repeating moiety of formula (B) and a portion of MAO having a structure derived from the repeating moiety of formula (B).

Alternatively, or additionally, to a portion of the MAO being covalently bonded to the LDH via the latter's surface hydroxyl groups, the LDH may comprise a quantity of MAO intercalated within its anionic gallery (i.e. between the cationic layers of metal hydroxides).

As alluded to hereinbefore, the modifying compound, or a moiety derived therefrom, having a structure according to formula (I) may be a free-standing compound (in which case X is selected from hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl) or may be covalently bonded to either or both of the LDH and MAO (in which case X represents a portion of the layered double hydroxide or the methylaluminoxane).

When the modifying compound, or a moiety derived therefrom, having a structure according to formula (I) is a free-standing compound, the compound may nevertheless be associated with either or both of the LDH and MAO by one or more interactions including ionic, hydrogen bonding and Van der Waals interactions. Alternatively, or additionally, the compound may be located (e.g. intercalated) within the anionic gallery of the LDH (i.e. between the cationic layers of metal hydroxides).

When the modifying compound, or a moiety derived therefrom, having a structure according to formula (I) is covalently bonded to MAO, X is suitably Al (e.g. as a result of a protonolysis reaction with MAO, liberating methane). Hence, X may be an atom derived from MAO. The solid support material may therefore comprise a moiety having a structure according to formula (Ia) shown below:

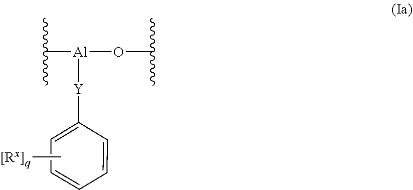

wherein Y, R^{x} and q are as defined in relation to formula (I).

When the modifying compound, or a moiety derived therefrom, having a structure according to formula (I) is covalently bonded to LDH, X is suitably an O atom (derived from the surface OH groups of the LDH). Hence, X may be an atom derived from LDH.

The following paragraphs provide preferred definitions of the groups X, Y, R^{x} and q of the modifying compound or moiety having a structure according to formula (I).

In an embodiment, X represents a portion (e.g. an atom) of the layered double hydroxide or the methylaluminoxane.

In an embodiment, X represents a portion (e.g. an atom) of the layered double hydroxide (e.g. X is a metal cation of the LDH).

In an embodiment, X represents a portion (e.g. an atom) of the methylaluminoxane (e.g. X is Al).

In an embodiment, X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl.

In an embodiment, X is hydrogen, chloro, hydroxyl or phenyl optionally substituted with one or more groups selected from chloro, fluoro, hydroxyl, (1-4C)alkyl and (1-4C)haloalkyl.

In an embodiment, X is hydrogen.

In an embodiment, X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl.

In an embodiment, X represents a portion of the layered double hydroxide or the methylaluminoxane, or X is hydrogen, chloro, hydroxyl or phenyl optionally substituted with one or more groups selected from chloro, fluoro, hydroxyl, (1-4C)alkyl and (1-4C)haloalkyl.

In an embodiment, X represents a portion of the layered double hydroxide or the methylaluminoxane, or X is perfluorophenyl or hydrogen

In an embodiment, X represents a portion of the layered double hydroxide or the methylaluminoxane, or X is hydrogen.

In an embodiment, Y is O or B(Q).

In an embodiment, Y is O.

In an embodiment, Y is B(Q).

In an embodiment, Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl.

In an embodiment, Q is selected from chloro, hydroxyl or phenyl optionally substituted with one or more groups selected from chloro, fluoro, hydroxyl, (1-4C)alkyl and (1-4C)haloalkyl.

In an embodiment, Q is chloro, hydroxyl, phenyl and perfluorophenyl.

In an embodiment, Q is perfluorophenyl.

In an embodiment, each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl.

In an embodiment, each R^{x} is independently selected from chloro, fluoro, hydroxyl, (1-4C)alkyl and (1-4C)fluoroalkyl, and/or two adjacent groups are linked, such that, when taken in combination with the atoms to which they are attached, they form a 6-membered aromatic ring that is optionally substituted with one or more groups selected from chloro, fluoro, hydroxyl, (1-4C)alkyl and (1-4C)fluoroalkyl.

In an embodiment, each R^{x} is independently selected from chloro, fluoro, hydroxyl, (1-4C)alkyl and (1-4C)fluoroalkyl.

In an embodiment, all R^{x} groups are identical.

In an embodiment, all R^{x} groups are fluoro.

In an embodiment, q is 1, 2 or 5.

In an embodiment, q is 1 or 2.

The following paragraphs outline preferred embodiments of the organic modifying compound or moiety having a structure according to formula (I).

In an embodiment, X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl;

### Y is O or B(Q);

Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl;
q is 1, 2 or 5.

In an embodiment, X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl;

### Y is O or B(Q);

Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl;
each R^{x} is independently selected from chloro, fluoro, hydroxyl, (1-4C)alkyl and (1-4C)fluoroalkyl, and/or two adjacent groups R^{x} are linked, such that, when taken in combination with the atoms to which they are attached, they form a 6-membered aromatic ring that is optionally substituted with one or more groups selected from chloro, fluoro, hydroxyl, (1-4C)alkyl and (1-4C)fluoroalkyl;
q is 1, 2 or 5.

In an embodiment, X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl;

### Y is O or B(Q);

Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl;
each R^{x} is independently selected from chloro, fluoro, hydroxyl, (1-4C)alkyl and (1-4C)fluoroalkyl;
q is 1, 2 or 5.

In an embodiment, X represents a portion of the layered double hydroxide or the methylaluminoxane, or X is hydrogen;

### Y is O or B(Q);

Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl;
q is 1, 2 or 5.

In an embodiment, X represents a portion of the layered double hydroxide or the methylaluminoxane, or X is hydrogen;

### Y is O or B(Q);

Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl;
q is 1, 2 or 5.

In an embodiment, X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl;

### Y is O or B(Q);

Q is selected from chloro, hydroxyl or phenyl optionally substituted with one or more groups selected from chloro, fluoro, hydroxyl, (1-4C)alkyl and (1-4C)haloalkyl;
each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl;
q is 1, 2 or 5.

In an embodiment, X represents a portion of the layered double hydroxide or the methylaluminoxane, or X is hydrogen;

### Y is O or B(Q);

Q is selected from chloro, hydroxyl or phenyl optionally substituted with one or more groups selected from chloro, fluoro, hydroxyl, (1-4C)alkyl and (1-4C)haloalkyl;
each R^{x} is independently selected from chloro, fluoro, hydroxyl, (1-4C)alkyl and (1-4C)fluoroalkyl, and/or two adjacent groups R^{x} are linked, such that, when taken in combination with the atoms to which they are attached, they form a 6-membered aromatic ring that is optionally substituted with one or more groups selected from chloro, fluoro, hydroxyl, (1-4C)alkyl and (1-4C)fluoroalkyl;
q is 1, 2 or 5.

In an embodiment, X represents a portion of the layered double hydroxide or the methylaluminoxane, or X is perfluorophenyl or hydrogen;

### Y is O or B(Q);

Q is phenyl substituted with one or more groups selected from chloro and fluoro;
each R^{x} is independently selected from chloro and fluoro; and
q is 1, 2 or 5.

In a particularly suitable embodiment, the modifying compound or moiety having a structure according to formula (I) has any one or more of the following structures:

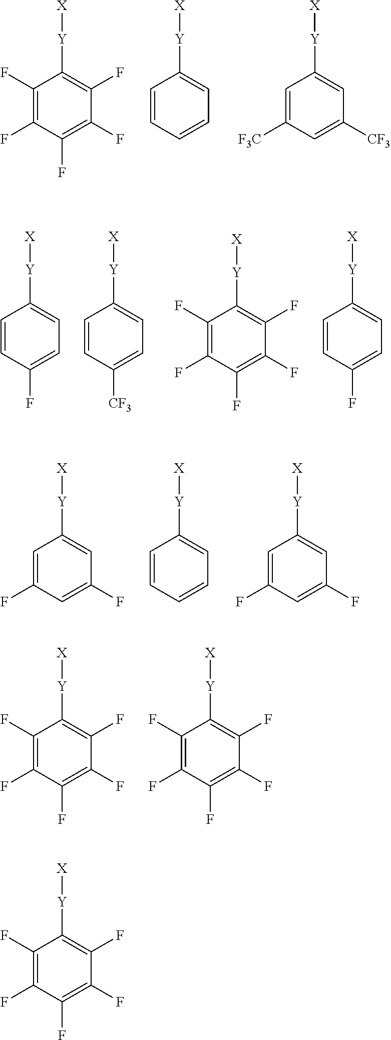

wherein X and Y have any of the definitions appearing hereinbefore.

In a particularly suitable embodiment, the modifying compound or moiety having a structure according to formula (I) has any one or more of the following structures:

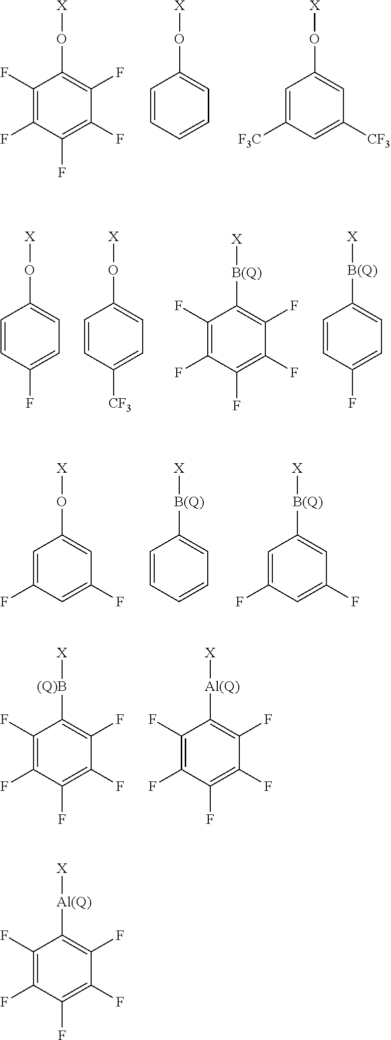

wherein X and Q have any of the definitions appearing hereinbefore. Suitably, Q is selected from chloro, hydroxyl or phenyl optionally substituted with one or more groups selected from chloro, fluoro, hydroxyl, (1-4C)alkyl and (1-4C)haloalkyl. More suitably, Q is chloro, hydroxyl, phenyl or perfluorophenyl. More suitably, Q is perfluorophenyl.

In a particularly suitable embodiment, the modifying compound or moiety having a structure according to formula (I) has any one or more of the following structures:

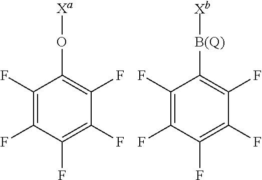

wherein X^{a} and X^{b} have any of the definitions appearing hereinbefore in respect of X, and Q has any of the definitions appearing hereinbefore in respect of Q. Suitably, X^{a} represents a portion of the layered double hydroxide or the methylaluminoxane, or X^{a} is hydrogen, and X^{b} represents a portion of the layered double hydroxide or the methylaluminoxane, or X^{b} is perfluorophenyl. Suitably, Q is perfluorophenyl.

In any of the embodiments of the first aspect of the present invention, the compound or moiety of formula (I) may be replaced, or supplemented, with a compound or moiety of formula (II) shown below:

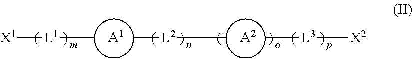

wherein
X¹ and X² are independently selected from OH, COOH, SH, PR^{v}R^{w}H and NR^{v}H, or their deprotonated forms;
rings A¹ and A² are independently aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
L¹, L² and L³ are independently selected from (1-5C)alkylene and phenylene, and are optionally substituted with one or more groups selected from OH, halo, (1-3C)alkyl and (1-3C)haloalkyl;
R^{v} and R^{w} are independently selected from hydrogen and (1-4C)alkyl;
m is 0 or 1;
n is 0 or 1;
o is 0 or 1; and
p is 0 or 1.

The modifying compound or moiety having a structure according to formula (II) may be a free-standing compound (in which case, X¹ and X² are independently selected from OH, COOH, SH, PR^{v}R^{w}H and NR^{v}H) or may be covalently bonded to either or both of the LDH and MAO (in which case X¹ and X² exist in a deprotonated form of OH, COOH, SH, PR^{v}R^{w}H and NR^{v}H).

When the modifying compound or moiety having a structure according to formula (II) is a free-standing compound, the compound may nevertheless be associated with either or both of the LDH and MAO by one or more interactions including ionic, hydrogen bonding and Van der Waals interactions. Alternatively, or additionally, the compound may be located (e.g. intercalated) within the anionic gallery of the LDH (i.e. between the cationic layers of metal hydroxides).

When the modifying compound or moiety having a structure according to formula (II) is covalently bonded to MAO, the solid support material may comprise a moiety having a structure according to formula (IIa) shown below:

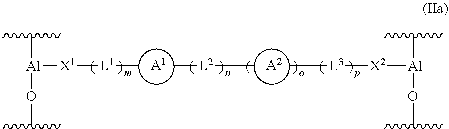

wherein

X¹ and X² are independently selected from O, COO, S, PR^{v}R^{w} and NR^{v}, and

A¹, A², L¹, L², L³, R^{v}, R^{w}, m, n, o and p are as defined in formula (II).

Without wishing to be bound by theory, it is believed that the structure of the compound or moiety of formula (II) has an effect on the overall morphology of the solid support material. In particular, the ability of groups X¹ and X² to each associate with a different particulate of the MAO and/or LDH allows for the formation of a network of LDHMAO particulates interconnected by compounds or moieties of formula (II) acting as linking groups. It is believed that the formation of such networks results in the creation of channels within the solid support material, which may give rise to an increase in specific surface area.

The following paragraphs provide preferred definitions of the groups X¹, X², A¹, A², L¹, L², L³, R^{v}, R^{w}, m, n, o and p of formula (II).

In an embodiment, X¹ and X² are independently selected from OH, COOH, SH, PR^{v}R^{w}H and NR^{v}H, or their deprotonated forms, wherein R^{v} is independently selected from hydrogen and (1-4C)alkyl.

In an embodiment, X¹ and X² are independently selected from OH, COOH, SH and NR^{v}H, or their deprotonated forms, wherein R^{v} is independently selected from hydrogen and (1-4C)alkyl.

In an embodiment, X¹ and X² are independently selected from OH, COOH and NR^{v}H, or their deprotonated forms, wherein R^{v} is independently selected from hydrogen and (1-4C)alkyl.

In an embodiment, X¹ and X² are independently selected from OH and NR^{v}H, or their deprotonated forms, wherein R^{v} is independently selected from hydrogen and (1-4C)alkyl.

In an embodiment, X¹ and X² are independently selected from OH and COOH, or their deprotonated forms.

In a particularly suitable embodiment, X¹ and X² are OH, or its deprotonated form.

In an embodiment, rings A¹ and A² are independently aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl, wherein R^{v} and R^{w} are independently selected from hydrogen and (1-4C)alkyl.

In an embodiment, rings A¹ and A² are independently monocyclic or bicyclic aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl, wherein R^{v} and R^{w} are independently selected from hydrogen and (1-4C)alkyl.

In an embodiment, rings A¹ and A² are independently monocyclic or bicyclic aromatic or heteroaromatic, and are optionally substituted with one or more groups R¹ selected from OH, COOH, NR^{v}R^{w}, halo, (1-5C)alkyl, (1-5C)alkoxy, phenyl and 5-6 membered heteroaryl, wherein R^{v} and R^{w} are independently selected from hydrogen and (1-4C)alkyl.

In an embodiment, rings A¹ and A² are independently monocyclic or bicyclic aromatic, and are optionally substituted with one or more groups R¹ selected from OH, COOH, NR^{v}R^{w}, halo, (1-5C)alkyl, (1-5C)alkoxy, phenyl and 5-6 membered heteroaryl, wherein R^{v} and R^{w} are independently selected from hydrogen and (1-4C)alkyl.

In an embodiment, rings A¹ and A² are independently phenyl or naphthyl, and are optionally substituted with one or more groups R¹ selected from OH, COOH, NR^{v}R^{w}, halo, (1-5C)alkyl, (1-5C)alkoxy and phenyl, wherein R^{v} and R^{w} are independently selected from hydrogen and (1-4C)alkyl.

In an embodiment, rings A¹ and A² are independently phenyl or naphthyl, and are optionally substituted with one or more groups R¹ selected from OH, halo, (1-5C)alkyl and phenyl.

In an embodiment, rings A¹ and A² are independently phenyl or naphthyl, and are optionally substituted with one or more groups R¹ selected from OH, chloro, fluoro and (1-3C)alkyl.

In an embodiment, rings A¹ and A² independently have any one the following structures:

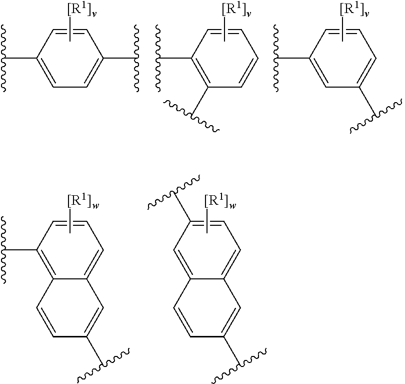

wherein

R¹ has any of the definitions outlined herein (e.g. halo, such as fluoro),

v is 0 to 4 (e.g. 0 or 4), and

w is 0 to 6 (e.g. 0).

In an embodiment, L¹, L² and L³ are independently selected from (1-5C)alkylene and phenylene, and are optionally substituted with one or more groups selected from OH, halo, (1-3C)alkyl and (1-3C)haloalkyl.

In an embodiment, L¹, L² and L³ are independently selected from (1-3C)alkylene and phenylene, and are optionally substituted with one or more groups selected from OH, halo, (1-3C)alkyl and (1-3C)haloalkyl.

In an embodiment, L¹, L² and L³ are independently selected from (1-3C)alkylene, and are optionally substituted with one or more groups selected from halo, (1-3C)alkyl and (1-3C)haloalkyl.

In an embodiment, L¹, L² and L³ are independently (1-3C)alkylene, and are optionally substituted with one or more groups selected from (1-3C)alkyl and (1-3C)haloalkyl.

In an embodiment, L¹, L² and L³ are methylene, and are optionally substituted with one or more groups selected from (1-2C)alkyl and (1-2C)fluoroalkyl.

In an embodiment, m is 0 or 1.

In an embodiment, m is 0.

In an embodiment, n is 0 or 1.

In an embodiment, n is 1.

In an embodiment, o is 0 or 1.

In an embodiment, o is 1.

In an embodiment, p is 0 or 1.

In an embodiment, p is 0.

In an embodiment, n is 1 and o is 1.

In an embodiment, m is 0 and p is 0.

In a particularly suitable embodiment, m is 0, n is 1, o is 1 and p is O.

The following paragraphs outline preferred embodiments of the compound or moiety of formula (II).

In an embodiment, X¹ and X² are independently selected from OH, COOH, SH, PR^{v}R^{w}H and NR^{v}H, or their deprotonated forms;

A¹ and A² are independently monocyclic or bicyclic aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
R^{v} and R^{w} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH and NR^{v}H, or their deprotonated forms;

A¹ and A² are independently monocyclic or bicyclic aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
R^{v} and R^{w} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are OH, or its deprotonated form;

A¹ and A² are independently monocyclic or bicyclic aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
R^{v} and R^{w} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are OH, or its deprotonated form;

A¹ and A² are independently monocyclic or bicyclic aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
R^{v} and R^{w} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m and p are independently 0 or 1;
n and o are 1.

In an embodiment, X¹ and X² are independently selected from OH, COOH, SH and NR^{v}H, or their deprotonated forms;

rings A¹ and A² are independently monocyclic or bicyclic aromatic or heteroaromatic, and are optionally substituted with one or more groups R¹ selected from OH, COOH, NR^{v}R^{w}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

rings A¹ and A² are independently phenyl or naphthyl, and are optionally substituted with one or more groups R¹ selected from OH, COOH, NR^{v}R^{w}, halo, (1-5C)alkyl, (1-5C)alkoxy and phenyl;
R^{v} and R^{w} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

rings A¹ and A² are independently phenyl or naphthyl, and are optionally substituted with one or more groups R¹ selected from OH, chloro, fluoro and (1-3C)alkyl;
R^{v} and R^{w} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

rings A¹ and A² independently have any one the following structures:

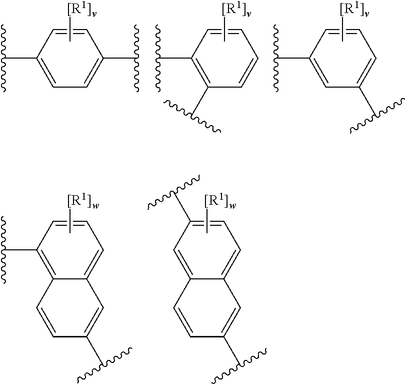

wherein

R¹ has any of the definitions outlined herein (e.g. halo, such as fluoro),

v is 0 to 4 (e.g. 0 or 4), and

w is 0 to 6 (e.g. 0);

R^{v} and R^{w} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

rings A¹ and A² independently have any one the following structures:

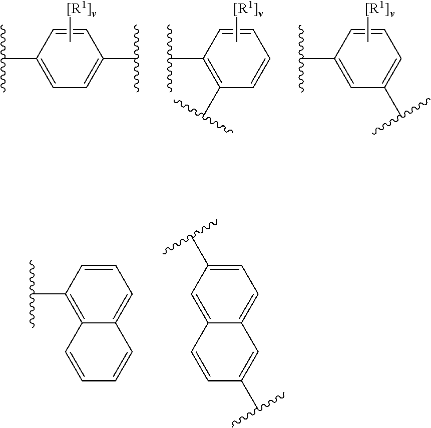

wherein

R¹ is selected from OH, COOH, NR^{v}R^{w}, halo (e.g. fluoro), (1-5C)alkyl, (1-5C)alkoxy and

phenyl, and

v is 0 or 4;

R^{v} and R^{w} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m and p are independently 0 or 1;
n and o are 1.

In an embodiment, X¹ and X² are independently selected from OH, COOH, SH and NR^{v}H, or their deprotonated forms;

A¹ and A² are independently monocyclic or bicyclic aromatic, and are optionally substituted with one or more groups R¹ selected from OH, COOH, NR^{v}R^{w}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are independently selected from (1-5C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

A¹ and A² are independently monocyclic or bicyclic aromatic, and are optionally substituted with one or more groups R¹ selected from OH, COOH, NR^{v}R^{w}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are independently (1-3C)alkylene, and are optionally substituted with one or more groups selected from (1-3C)alkyl and (1-3C)haloalkyl;
m, n, o and p are independently 0 or 1.

In an embodiment, X¹ and X² are independently selected from OH, COOH, SH and NR^{v}H, or their deprotonated forms;

A¹ and A² are independently monocyclic or bicyclic aromatic, and are optionally substituted with one or more groups R¹ selected from OH, COOH, NR^{v}R^{w}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are methylene, and are optionally substituted with one or more groups selected from (1-2C)alkyl and (1-2C)fluoroalkyl;
m, n, o and p are independently 0 or 1.

In an embodiment, X¹ and X² are independently selected from OH, COOH, SH and NR^{x}H, or their deprotonated forms;

A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are independently selected from OH, COOH, SH and NR^{v}H, or their deprotonated forms;

rings A¹ and A² are independently monocyclic or bicyclic aromatic or heteroaromatic, and are optionally substituted with one or more groups R¹ selected from OH, COOH, NR^{v}R^{w}, halo, (1-5C)alkyl, (1-5C)alkoxy, phenyl and 5-6 membered heteroaryl;
R^{v} and R^{w} are independently selected from hydrogen and (1-4C)alkyl;
L¹, L² and L³ are independently (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH and NR^{v}H, or their deprotonated forms;

rings A¹ and A² are independently phenyl or naphthyl, and are optionally substituted with one or more groups R¹ selected from OH, COOH, NR^{v}R^{w}, halo, (1-5C)alkyl, (1-5C)alkoxy and phenyl;
R^{v} and R^{w} are independently selected from hydrogen and (1-4C)alkyl;
L¹, L² and L³ are independently (1-3C)alkylene, and are optionally substituted with one or more groups selected from (1-3C)alkyl and (1-3C)haloalkyl;
m and p are independently 0 or 1;
n and o are 1.

In an embodiment, X¹ and X² are independently selected from OH and COOH, or their deprotonated forms;

rings A¹ and A² are independently phenyl or naphthyl, and are optionally substituted with one or more groups R¹ selected from OH, chloro, fluoro and (1-3C)alkyl;
L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are independently selected from OH and COOH (e.g. OH), or their deprotonated forms;

ring A¹ is unsubstituted phenyl or phenyl substituted with one, two, three or four (e.g. three or four) groups R¹ selected from chloro and fluoro (e.g. fluoro); and
m, n, o and p are 0.

In an embodiment, X¹ and X² are OH or its deprotonated form;

ring A¹ is phenyl substituted with three or four groups R¹ being fluoro; and
m, n, o and p are 0.

In an embodiment, X¹ and X² are OH, or its deprotonated form;

rings A¹ and A² independently have any one the following structures:

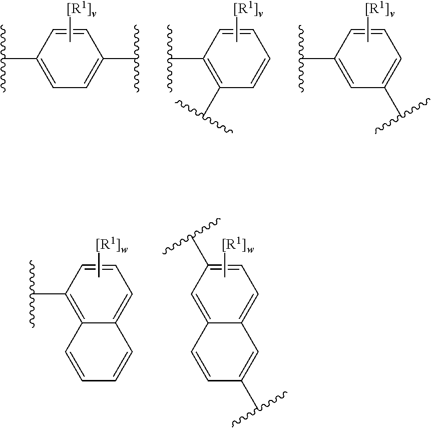

wherein

R¹ has any of the definitions outlined herein (e.g. halo, such as fluoro),

v is 0 to 4 (e.g. 0 or 4), and

w is 0 to 6 (e.g. 0).

L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are OH, or its deprotonated form;

ring A¹ has any one of the following structures:

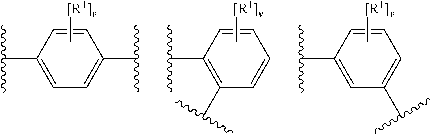

wherein

each R¹ is independently chloro or fluoro (e.g. fluoro), and

v is 0, 1, 2, 3 or 4 (e.g. 0, 3 or 4); and m, n, o and p are 0.

In an embodiment, X¹ and X² are OH, or its deprotonated form;
ring A¹ has the following structure:

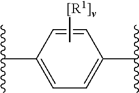

wherein

each R¹ is independently chloro or fluoro (e.g. fluoro), and

v is 0, 1, 2, 3 or 4 (e.g. 0, 3 or 4); and

m, n, o and p are 0.

In an embodiment, X¹ and X² are OH, or its deprotonated form;

ring A¹ has the following structure:

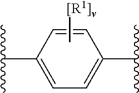

wherein

each R¹ is fluoro, and

v is 3 or 4; and

m, n, o and p are 0.

In an embodiment, the compound or moiety of formula (II) has any one or more of the following structures:

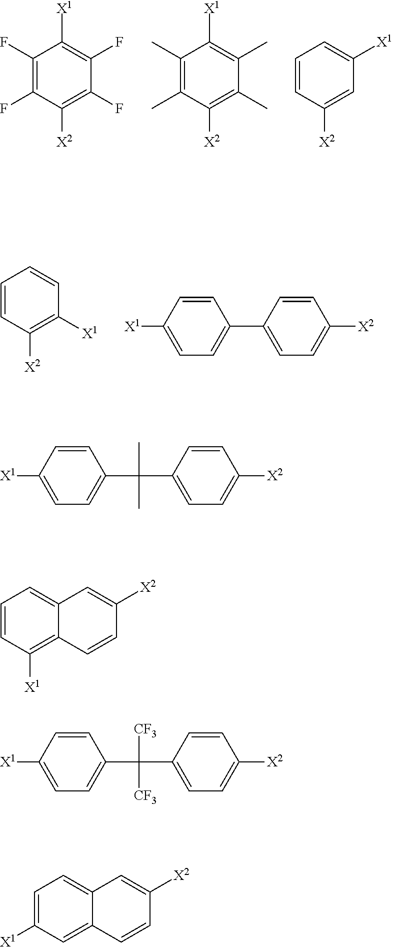

wherein X¹ and X² are independently selected from OH, COOH, SH, PR^{v}R^{w}H and NR^{v}H, or their deprotonated forms, wherein R^{v} and R^{w} are independently selected from hydrogen and (1-4C)alkyl. Suitably, X¹ and X² are independently selected from OH, COOH, SH and NR^{v}H, or their deprotonated forms, wherein R^{v} is independently selected from hydrogen and (1-4C)alkyl. More suitably, X¹ and X² are independently selected from OH, COOH and NR^{v}H, or their deprotonated forms, wherein R^{x} is independently selected from hydrogen and (1-4C)alkyl. Most suitably, X¹ and X² are OH, or its deprotonated form.

In a particularly suitable embodiment, the modifying compound or moiety having a structure according to formula (I) and/or (II) has any one or more of the following structures:

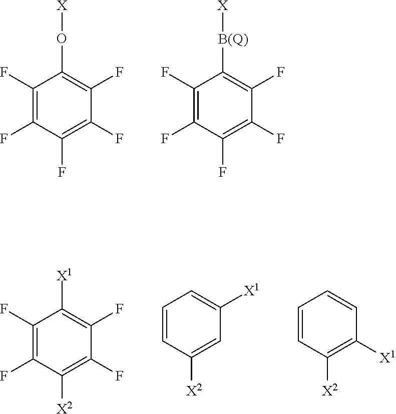

wherein X, X¹, X² and Q have any of the definitions appearing hereinbefore.

In a particularly suitable embodiment, the modifying compound or moiety having a structure according to formula (I) and/or (II) has any one or more of the following structures:

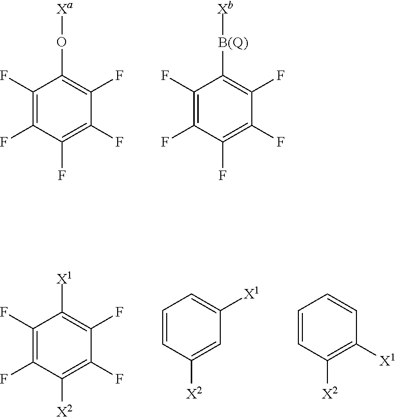

wherein
X^{a} represents a portion of the layered double hydroxide or the methylaluminoxane, or X^{a} is hydrogen;
X^{b} represents a portion of the layered double hydroxide or the methylaluminoxane, or X^{a} is perfluorophenyl;
Q is perfluorophenyl; and
X¹ and X² are OH, or its deprotonated form.

In an embodiment, the solid support material comprises 50-70 wt % of LDH and 30-50 wt % of MAO relative to the total mass of the solid support material.

In an embodiment, the solid support material comprises 55-80 wt % of LDH and 20-45 wt % of MAO. Suitably, the solid support material comprises 65-75 wt % of LDH and 25-35 wt % of MAO. More suitably, the solid support material comprises 68-75 wt % of LDH and 25-32 wt % of MAO.

The amount of compound or moiety of formula (I) and/or formula (II) within the solid support material is calculated relative to the number of moles of aluminium within the MAO, which can be determined by techniques such as elemental analysis and NMR spectroscopy. In an embodiment, the solid support material comprises 0.1-40 mol % of the compound or moiety of formula (I) and/or formula (II) relative to the number of moles of aluminium in the MAO. Suitably, the solid support material comprises 0.1-12.0 mol % of the compound or moiety of formula (I) and/or formula (II) relative to the number of moles of aluminium in the MAO. More suitably, the solid support material comprises 0.1-7.5 mol % of the compound or moiety of formula (I) and/or formula (II) relative to the number of moles of aluminium in the MAO. Most suitably, the solid support material comprises 2.5-7.5 mol % of the compound or moiety of formula (I) and/or formula (II) relative to the number of moles of aluminium in the MAO.

In an embodiment, the solid support material comprises 50-70 wt % of LDH and 30-50 wt % of MAO relative to the total mass of the solid support material, as well as 0.1-40 mol % of the compound or moiety of formula (I) and/or formula (II) relative to the number of moles of aluminium in the MAO.

### Preparation of Solid Support Materials

The second aspect of the invention provides a process for the preparation of a solid support material according to the first aspect, the process comprising the steps of
a) thermally treating a layered double hydroxide at a temperature of 100-500° C.;
b) in a suitable solvent, combining, in a single or multiple steps, the thermally-treated layered double hydroxide, a methylaluminoxane and a compound having a structure according to formula (I) shown below:

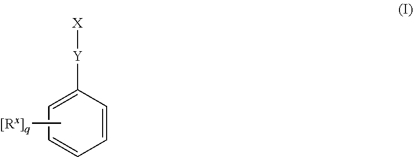

wherein
X is hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl;
Y is O, B(Q) or Al(Q)
   wherein Q is halo, hydroxyl or aryl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl, (2-4C)alkenyl, (2-4C)alkynyl and (1-4C)haloalkyl,
and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl, (2-4C)alkenyl, (2-4C)alkynyl and (1-4C)haloalkyl; and q is 0 to 5; and
c) Isolating the product formed from step b).

The compound of formula (I) may have any of those definitions discussed hereinbefore in respect of the first aspect of the invention, to the extent that X is hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl (i.e. the compound of formula (I) is a free-standing compound, as opposed to a moiety associated with a portion of LDH and/or MAO). It will be understood that suitable, preferred and particularly preferred embodiments of the first aspect of the invention are also suitable, preferred and particularly preferred embodiments of the second aspect of the invention.

In the second aspect of the present invention, the compound formula (I) may be replaced by, or supplemented with, a compound of formula (II) shown below

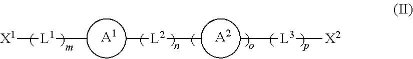

wherein
X¹ and X² are independently selected from OH, COOH, SH, PR^{v}R^{w}H and NR^{v}H;
rings A¹ and A² are independently aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
L¹, L² and L³ are independently selected from (1-5C)alkylene and phenylene, and are optionally substituted with one or more groups selected from OH, halo, (1-3C)alkyl and (1-3C)haloalkyl;
R^{v} and R^{w} are independently selected from hydrogen and (1-4C)alkyl;
m is 0 or 1;
n is 0 or 1;
o is 0 or 1; and
p is 0 or 1.

It will be appreciated that the compound having a structure according to formula (II) may be as defined in any of those embodiments outlined hereinbefore in respect of the first aspect of the invention. It will be understood that suitable, preferred and particularly preferred embodiments of the first aspect of the invention are also suitable, preferred and particularly preferred embodiments of the second aspect of the invention.

The LDH used in step a) may have any of those definitions discussed hereinbefore in respect of the first aspect of the invention.

In an embodiment, step a) comprises thermally treating the layered double hydroxide at a temperature of 150-250° C.

In an embodiment, step a) comprises thermally treating the layered double hydroxide at a temperature of 120-200° C.

In an embodiment, prior to step a), the layered double hydroxide is subjected to sonication.

The suitable solvent used in step b) may be selected from toluene, hexane, benzene, pentane and a mixture of two or more thereof. Suitably, the suitable solvent used in step b) is toluene.

Step b) may comprise a single step, or multiple sub-steps.

In an embodiment, step b) is conducted in a one-pot manner, which comprises contacting, in a first solvent, the thermally-treated layered double hydroxide, the methylaluminoxane and the compound of formula (I) and/or formula (II). The first solvent may be selected from toluene, hexane, benzene, pentane and a mixture of two or more thereof. Suitably, the first solvent is toluene. The reaction may be conducted at a temperature of 18-120° C. (e.g. 50-100° C.).

In another embodiment, step b) comprises two sub-steps, steps b)i) and b)ii). The first sub-step (step b)i)) comprises contacting, in a first solvent, the thermally-treated layered double hydroxide with the methylaluminoxane. The second sub-step (step b)ii)) comprises contacting, in a second solvent, the product resulting from step b)i) with the compound of formula (I) and/or formula (II). The first and second solvents may be identical or different, and may be selected from toluene, hexane, benzene, pentane and a mixture of two or more thereof. Suitably, the first and second solvents are toluene. Suitably, the first sub-step is conducted at a temperature of 18-120° C. (e.g. 50-100° C.). Suitably, the second sub-step is conducted at a temperature of 18-120° C. (e.g. 18-40° C.), optionally with the application of sonication.

In another embodiment, step b) comprises two sub-steps, steps b)i) and b)ii). The first sub-step (step b)i)) comprises contacting, in a first solvent, the thermally-treated layered double hydroxide with the compound of formula (I) and/or formula (II). The second sub-step (step b)ii)) comprises contacting, in a second solvent, the product resulting from step b)i) with the methylaluminoxane. The first and second solvents may be identical or different, and may be selected from toluene, hexane, benzene, pentane and a mixture of two or more thereof. Suitably, the first and second solvents are toluene. Suitably, the first and second sub-steps are independently conducted at a temperature of 18-120° C. (e.g. 50-100° C.).

In another embodiment, step b) comprises two sub-steps, steps b)i) and b)ii). The first sub-step (step b)i)) comprises contacting, in a first solvent, the methylaluminoxane with the compound of formula (I) and/or formula (II). The second sub-step (step b)ii)) comprises contacting, in a second solvent, the product resulting from step b)i) with the thermally-treated layered double hydroxide. The first and second solvents may be identical or different, and may be selected from toluene, hexane, benzene, pentane and a mixture of two or more thereof. Suitably, the first and second solvents are toluene. Suitably, the first and second sub-steps are independently conducted at a temperature of 18-120° C. (e.g. 50-100° C.).

In an embodiment, the amount of MAO used in step b) is 30-70 wt % based on the mass of the layered double hydroxide post-thermal treatment. Suitably, the amount of MAO used in step b) is 35-65 wt % based on the mass of the layered double hydroxide post-thermal treatment. For example, the amount of MAO used in step b) is 35-45 wt % based on the mass of the layered double hydroxide post-thermal treatment. Alternatively, the amount of MAO used in step b) is 50-65 wt % based on the mass of the layered double hydroxide post-thermal treatment.

In an embodiment, the amount of the compound of formula (I) and/or formula (II) used in step b) is 0.1-40 mol % relative to the number of moles of aluminium in the methylaluminoxane. Suitably, the amount of the compound of formula (I) and/or formula (II) used in step b) is 0.1-12.0 mol % relative to the number of moles of aluminium in the methylaluminoxane. More suitably, the amount of the compound of formula (I) and/or formula (II) used in step b) is 0.1-7.5 mol % relative to the number of moles of aluminium in the methylaluminoxane. For example, the amount of the compound of formula (I) and/or formula (II) used in step b) is 2.5 7.5 mol % relative to the number of moles of aluminium in the methylaluminoxane. Alternatively, the amount of the compound of formula (I) and/or formula (II) used in step b) is 3.5-7.5 mol % relative to the number of moles of aluminium in the methylaluminoxane.

In an embodiment, step b) comprises combining, in a single or multiple steps, the thermally-treated layered double hydroxide, the methylaluminoxane and the compound of formula (I) and/or formula (II) in quantities such that the solid support material comprises
a) 50-70 wt % of layered double hydroxide and 30-50 wt % of methylaluminoxane relative to total mass of the solid support material, and
b) 0.1-45 mol % (or 0.1-40 mol %, or 0.1-20 mol %) of the compound of formula (I) and/or formula (II) relative to the number of moles of aluminium in the methylaluminoxane.

### Catalytic Composition

The fourth aspect of the invention provides a catalytic composition comprising an olefin polymerisation catalyst supported on a solid support material according to the first or third aspect.

It will be understood that suitable, preferred and particularly preferred embodiments of the first and third aspects of the invention are also suitable, preferred and particularly preferred embodiments of the fourth aspect of the invention.

Any suitable olefin polymerisation catalyst may be used in the catalytic composition. In an embodiment, the olefin polymerisation catalyst is a Ziegler-Natta type catalyst (e.g. a metallocene-based Ziegler-Natta catalyst).

In an embodiment, the olefin polymerisation catalyst is a metallocene catalyst comprising a metal bound between two η⁵-cyclopentadienyl type ligands. The η⁵-cyclopentadienyl type ligands may be selected from η⁵-cyclopentadienyl, η⁵-pentalenyl, η⁵-indenyl and η⁵-fluorenyl.

In an embodiment, the olefin polymerisation catalyst has a structure according to formula (III) shown below:

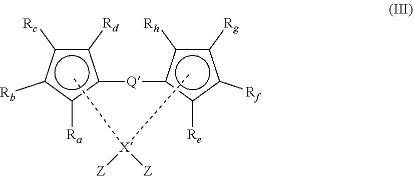

wherein
Rₐ and R_{b} are each independently hydrogen or (1-2C)alkyl;

R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;

Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
Q′ is absent (in which case each cycopentadienyl ring is bound to hydrogen at this position), or is a bridging group selected from —CH₂— or —CH₂CH₂—, either or which may be optionally substituted with one or more groups selected from (1-4C)alkyl, (2-4C)alkenyl, (2-4C)alkynyl and aryl, or Q′ is a bridging group —Si(Rᵢ)(Rⱼ)—, wherein R; and R are independently (1-4C)alkyl, (2-4C)alkenyl, (2-4C)alkynyl or aryl;
X′ is zirconium or hafnium; and
each Z group is independently selected from halo, hydrogen, (1-6C)alkyl, (1-6C)alkoxy, aryl or aryloxy, either or which is optionally substituted with one or more groups selected from (1-6C)alkyl and halo.

It will be appreciated that the structural formula (III) presented above is intended to show the substituent groups in a clear manner. A more representative illustration of the spatial arrangement of the groups is shown in the alternative representation below:

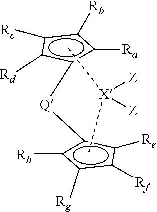

It will also be appreciated that, depending on the identities of substituents Rₐ-Rₕ, the compound of formula (III) may be present as meso or rac isomers, and the present invention includes both such isomeric forms. A person skilled in the art will appreciate that a mixture of isomers of the compound of formula (III) may be used for catalysis applications, or the isomers may be separated and used individually (using techniques well known in the art, such as, for example, fractional crystallization).

If the structure of a compound of formula (III) is such that rac and meso isomers do exist, the compound may be present in the rac form only, or in the meso form only.

The compound of formula (III) may be immobilized on the solid support material by one or more ionic or covalent interactions.

In the catalytic compositions of the invention, the solid support materials of the invention may be the only inorganic solid supports used (i.e. no additional solid support such as SiO₂, Al₂O₃ and ZrO₂ are necessary). Moreover, given the dual function of the solid support material of the invention (as catalytic support and activator species), the catalytic compositions of the invention may contain no additional catalytic activator species (e.g. co-catalysts).

In an embodiment, R^{a} and R^{b} are each hydrogen.

In an embodiment, Rₑ and R^{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from methyl, ethyl and tert-butyl.

In an embodiment, Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from methyl, ethyl and tert-butyl.

In an embodiment, R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from methyl, ethyl and tert-butyl.

In an embodiment, Q′ is absent, or is a bridging group selected from —CH₂— or —CH₂CH₂—, either or which may be optionally substituted with one or more groups selected from (1-4C)alkyl and phenyl, or Q′ is a bridging group —Si(Rᵢ)(Rⱼ)—,

wherein Rᵢ and Rⱼ are independently (1-4C)alkyl or aryl.

In an embodiment, X′ is zirconium.

In an embodiment, each Z group is independently selected from halo.

Suitably, each Z group is chloro.

In an embodiment, the olefin polymerisation catalyst having a structure according to formula (III) has any of the structures shown below:

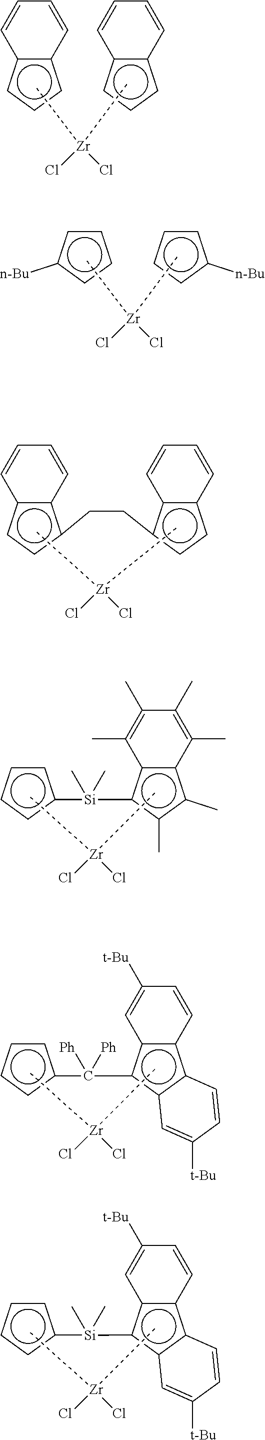

In a particular embodiment, the olefin polymerisation catalyst having a structure according to formula (III) has either of the following structures:

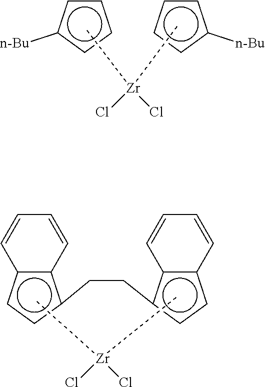

The quantity of the compound having a structure according to formula (III) in the catalytic composition can be expressed by the number of moles of metal X′ in the olefin polymerisation catalyst having a structure according to formula (III) relative to the number of moles of Al in the methylaluminoxane of the solid support material, i.e. [Al_{MAO}]/[X′]. Suitably, [Al_{MAP}]/[X′] is 50-250. More suitably, [Al_{MAO}]/[X′] is 75-225. For example, [Al_{MAO}]/[X′] is 95-150. Alternatively, [Al_{MAO}]/[X′] is 150-225.

### Preparation of Catalytic Compositions

The fifth aspect of the invention provides a process for the preparation of a catalytic composition according to the fourth aspect, the process comprising the steps of:
a) providing, in a suitable solvent, a solid support material according to the first or third aspect of the invention;
b) contacting the solid support material with an olefin polymerisation catalyst, and
c) isolating the product resulting from step b).

The olefin polymerisation catalyst may have any of those definitions discussed hereinbefore in respect of the fourth aspect of the invention.

The catalytic compositions of the invention are straightforwardly prepared using mild reaction conditions.

Suitable solvents for use in step a) will be well known to one of ordinary skill in the art, and include toluene, o-xylene, mesitylene, pentane, hexane, heptane, cyclohexane and methylcyclohexane. Suitably, the solvent used in step a) is toluene.

Step b) may involve mixing the reagents for a period of 0.05-6 hours. Step b) may be conducted at a temperature of 25-100° C.

### Applications

The sixth aspect of the invention provides a process for the preparation of a polyolefin, the process comprising the step of:
a) contacting olefin monomers with a catalytic composition according to the fifth aspect of the invention.

In an embodiment, the polyolefin is polyethylene and the olefin monomers are ethene monomers.

In another embodiment, the polyolefin is a copolymer, and the olefin monomers are a mixture of monomers comprising 90-99 wt % ethene and 1-10 wt % of one or more (4-8C) α-olefin. Suitably, the (4-8C) α-olefin is 1-butene, 1-hexene, 1-octene, or a mixture thereof.

A person skilled in the art of olefin polymerisation will be able to select suitable reaction conditions (e.g. temperature, pressures, reaction times etc.) for such a polymerisation reaction. A person skilled in the art will also be able to manipulate the process parameters in order to produce a polyolefin having particular properties

The following numbered statements 1-76 are not claims, but instead serve to define particular aspects and embodiments of the invention:
1. A solid support material suitable for supporting an olefin polymerisation catalyst, the solid support material comprising:
   a) a layered double hydroxide;
   b) a methylaluminoxane associated with the layered double hydroxide; and
   c) a compound or moiety having a structure according to formula (I) and/or formula (II) shown below:

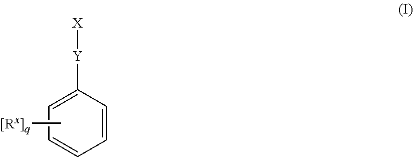

wherein
X represents a portion of the layered double hydroxide or the methylaluminoxane, or X is hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl;
Y is O, B(Q) or Al(Q)
wherein Q is halo, hydroxyl or aryl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl, (2-4C)alkenyl, (2-4C)alkynyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl, (2-4C)alkenyl, (2-4C)alkynyl and (1-4C)haloalkyl; and
q is 0 to 5;

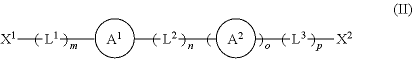

wherein
X¹ and X² are independently selected from OH, COOH, SH, PR^{v}R^{w}H and NR^{v}H, or their deprotonated forms;
rings A¹ and A² are independently aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl; L¹, L² and L³ are independently selected from (1-5C)alkylene and phenylene, and are optionally substituted with one or more groups selected from OH, halo, (1-3C)alkyl and (1-3C)haloalkyl;
R^{v} and R^{w} are independently selected from hydrogen and (1-4C)alkyl;
m is 0 or 1;
n is 0 or 1;
o is 0 or 1; and
p is 0 or 1.
2. The solid support material of statement 1, wherein X represents a portion of the layered double hydroxide or the methylaluminoxane, or X is hydrogen, halo, hydroxyl or phenyl optionally substituted with one or more groups selected from halo, hydroxyl, (1-4C)alkyl, (2-4C)alkenyl, (2-4C)alkynyl and (1-4C)haloalkyl.
3. The solid support material of statement 1 or 2, wherein X represents a portion of the layered double hydroxide or the methylaluminoxane, or X is hydrogen, chloro, hydroxyl or phenyl optionally substituted with one or more groups selected from chloro, fluoro, hydroxyl, (1-4C)alkyl and (1-4C)haloalkyl.
4. The solid support material of statement 1, 2 or 3, wherein X represents a portion of the layered double hydroxide or the methylaluminoxane, or X is perfluorophenyl or hydrogen.
5. The solid support material of any preceding statement, wherein X represents a portion of the layered double hydroxide or the methylaluminoxane, or X is hydrogen.
6. The solid support material of any preceding statement, wherein X represents a portion of the layered double hydroxide or the methylaluminoxane.
7. The solid support material of any preceding statement, wherein Y is O or B(Q).
8. The solid support material of any preceding statement, wherein Y is O.
9. The solid support material of any preceding statement, wherein Q is selected from halo, hydroxyl or phenyl optionally substituted with one or more groups selected from halo, hydroxyl, (1-4C)alkyl, (2-4C)alkenyl, (2-4C)alkynyl and (1-4C)haloalkyl.
10. The solid support material of any preceding statement, wherein Q is selected from chloro, hydroxyl or phenyl optionally substituted with one or more groups selected from chloro, fluoro, hydroxyl, (1-4C)alkyl and (1-4C)haloalkyl.
11. The solid support material of any preceding statement, wherein Q is perfluorophenyl.
12. The solid support material of any preceding statement, wherein each R^{x} is independently selected from halo, hydroxyl, (1-4C)alkyl and (1-4C)haloalkyl, and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl and (1-4C)haloalkyl.
13. The solid support material of any preceding statement, wherein each R^{x} is independently selected from chloro, fluoro, hydroxyl, (1-4C)alkyl and (1-4C)fluoroalkyl, and/or two adjacent groups R^{x} are linked, such that, when taken in combination with the atoms to which they are attached, they form a 6-membered aromatic ring that is optionally substituted with one or more groups selected from chloro, fluoro, hydroxyl, (1-4C)alkyl and (1-4C)fluoroalkyl.
14. The solid support material of any preceding statement, wherein each R^{x} is independently selected from chloro, fluoro, hydroxyl, (1-4C)alkyl and (1-4C)fluoroalkyl.
15. The solid support material of any preceding statement, wherein all R^{x} groups are identical.
16. The solid support material of any preceding statement, wherein all R^{x} groups are fluoro.
17. The solid support material of any preceding statement, wherein q is 1, 2 or 5.
18. The solid support material of any preceding statement, wherein q is 1 or 2.
19. The solid support material of any preceding statement, wherein
   X represents a portion of the layered double hydroxide or the methylaluminoxane, or X is perfluorophenyl or hydrogen;
      Y is O or B(Q);
      Q is phenyl substituted with one or more groups selected from chloro and fluoro; each R^{x} is independently selected from chloro and fluoro; and
      q is 1, 2 or 5.
20. The solid support material of any preceding statement, wherein the modifying compound or moiety having a structure according to formula (I) has any one or more of the following structures:

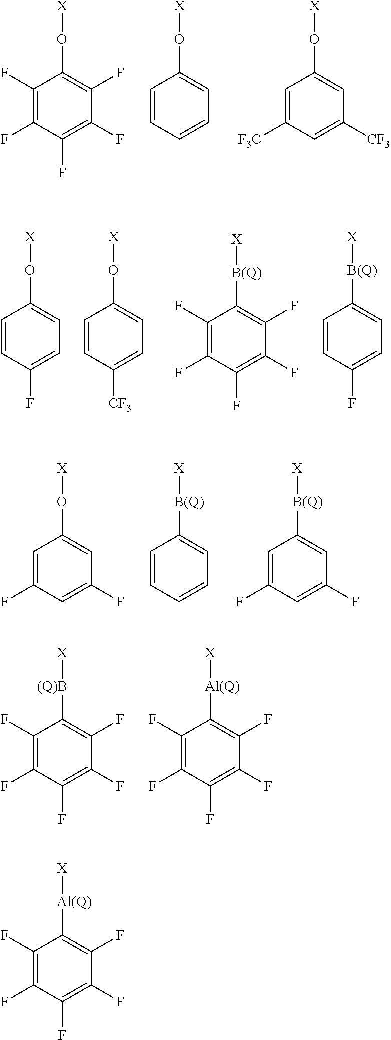

21. The solid support material of any preceding statement, wherein the modifying compound or moiety having a structure according to formula (I) has any one or more of the following structures:

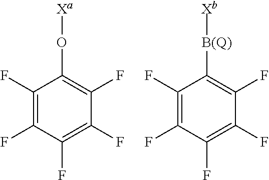

wherein
X^{a} represents a portion of the layered double hydroxide or the methylaluminoxane, or X^{a} is hydrogen;
X^{b} represents a portion of the layered double hydroxide or the methylaluminoxane, or X^{b} is perfluorophenyl; and
Q is perfluorophenyl.
22. The solid support material of any preceding statement, wherein the methylaluminoxane is associated with the layered double hydroxide as a result of one or more of ionic, covalent, hydrogen bonding or Van der Waals interactions.
23. The solid support material of any preceding statement, wherein at least a portion of the methylaluminoxane is covalently bonded to the surface of the layered double hydroxide.
24. The solid support material of any preceding statement, wherein at least a portion of the methylaluminoxane is located between the cationic layers of the layered double hydroxide.
25. The solid support material of any preceding statement, wherein the solid support material comprises 50-70 wt % of layered double hydroxide and 30-50 wt % of methylaluminoxane relative to the total mass of the solid support material.
26. The solid support material of any preceding statement, wherein the solid support material comprises 55-80 wt % of LDH and 20-45 wt % of MAO.
27. The solid support material of any preceding statement, wherein the solid support material comprises 65-75 wt % of LDH and 25-35 wt % of MAO.
28. The solid support material of any preceding statement, wherein the solid support material comprises 68-75 wt % of LDH and 25-32 wt % of MAO.
29. The solid support material of any preceding statement, wherein
   X¹ and X² are independently selected from OH and COOH (e.g. OH), or their deprotonated forms;
   ring A¹ is unsubstituted phenyl or phenyl substituted with one, two, three or four (e.g. three or four) groups R¹ selected from chloro and fluoro (e.g. fluoro); and m, n, o and p are 0.
30. The solid support material of any preceding statement, wherein
   X¹ and X² are OH, or its deprotonated form;
   ring A¹ has any one of the following structures:

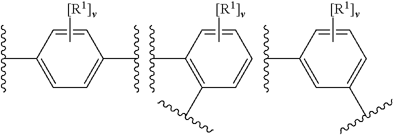

wherein
each R¹ is independently chloro or fluoro (e.g. fluoro), and
v is 0, 1, 2, 3 or 4 (e.g. 0, 3 or 4); and
m, n, o and p are 0.
31. The solid support material of any one of statements 1 to 28, wherein the compound or moiety of formula (II) has any one or more of the following structures:

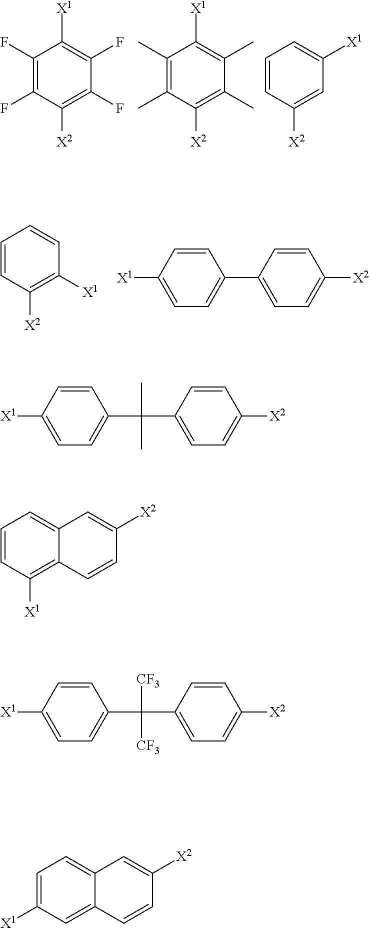

wherein X¹ and X² are OH, or its deprotonated form.
32. The solid support material of any preceding statement, wherein the compound or moiety of formula (II) has any one or more of the following structures:

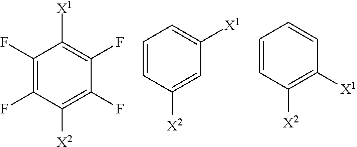

wherein X¹ and X² are OH, or its deprotonated form.
33. The solid support material of any preceding statement, wherein the solid support material comprises 0.1-40 mol % of the compound of formula (I) (and/or formula (II)) relative to the number of moles of aluminium in the methylaluminoxane.
34. The solid support material of any preceding statement, wherein the solid support material comprises 0.1-12.0 mol % of the compound of formula (I) (and/or formula (II)) relative to the number of moles of aluminium in the methylaluminoxane.
35. The solid support material of any preceding statement, wherein the solid support material comprises 0.1-7.5 mol % of the compound of formula (I) (and/or formula (II)) relative to the number of moles of aluminium in the methylaluminoxane.
36. The solid support material of any preceding statement, wherein the solid support material comprises 2.5-7.5 mol % of the compound of formula (I) (and/or formula (II)) relative to the number of moles of aluminium in the methylaluminoxane.
37. The solid support material of any preceding statement, wherein the layered double hydroxide comprises a first metal cation M selected from Mg²⁺, Zη²⁺, Ca²⁺, Fe²⁺, Ni²⁺, Co²⁺, Mn²⁺, Cu²⁺ and Li⁺.
38. The solid support material of statement 38, wherein the layered double hydroxide comprises a second metal cation M′ selected from Al³⁺, Ga³⁺, Y³⁺, lη³⁺, Fe³⁺, Co³⁺, Ni³⁺, Mn³⁺, Cr³⁺, Ti³⁺, V³⁺, La⁴⁺, Sn⁴⁺, Ti⁴⁺ and Zr⁴⁺.
39. The solid support material of statement 39, wherein M and M′ are such that the layered double hydroxide is a Mg/Al, Ca/Al, Ni/Al, Cu/Al or a Zn/Al layered double hydroxide.
40. The solid support material of any preceding statement, wherein the layered double hydroxide comprises at least one anion selected from carbonate, bicarbonate, hydrogenphosphate, dihydrogenphosphate, nitrite, borate, nitrate, phosphate and sulphate.
41. The solid support material of any preceding statement, wherein the layered double hydroxide comprises at least one anion selected from carbonate, nitrate, nitrite and sulphate.
42. The solid support material of any preceding statement, wherein the layered double hydroxide comprises at least one carbonate anion.
43. The solid support material of any preceding statement, wherein the layered double hydroxide is a magnesium aluminium carbonate layered double hydroxide.
44. The solid support material of any one of statements 1 to 36, wherein the layered double hydroxide has a composition according to formula (A) shown below:

[M^{z+}₁₋ₓM^{′y+}ₓ(OH)₂]^{a+}(Xⁿ⁻)ₘ.bH₂O.c(solvent) (A)
wherein
M is a charged metal cation;
M′ is a charged metal cation different from M;
z is 1 or 2;
y is 3 or 4;
0<x<0.9;
0<b≤10;
0≤c≤10
X is an anion;
n is the charge on anion X;
a is equal to z(1−x)+xy−2;
m≤a/n; and
the solvent is an organic solvent capable of hydrogen-bonding to water.
45. A process for the preparation of a solid support material as defined in any preceding statement, the process comprising the steps of:
   a) thermally treating a layered double hydroxide at a temperature of 100-500° C.;
   b) in a suitable solvent, combining, in a single or multiple steps, the thermally-treated layered double hydroxide, a methylaluminoxane and a compound having a structure according to formula (I) and/or (II) as defined in any preceding statement,
   c) isolating the product resulting from step b).
46. The process of statement 45, wherein the suitable solvent is selected from toluene, hexane, benzene, pentane and a mixture of two or more thereof.
47. The process of statement 45 or 46, wherein step b) comprises contacting, in a first solvent, the thermally-treated layered double hydroxide, the methylaluminoxane and the compound of formula (I) and/or formula (II).
48. The process of statement 45 or 46, wherein step b) comprises the sub-steps:
   bi) contacting, in a first solvent, the thermally-treated layered double hydroxide and the methylaluminoxane (optionally under sonication), and
   bii) contacting, in a second solvent, the product resulting from step b)i) with the compound of formula (I) and/or formula (II).
49. The process of statement 45 or 46, wherein step b) comprises the sub-steps:
   bi) contacting, in a first solvent, the thermally-treated layered double hydroxide and the compound of formula (I) and/or formula (II), and
   bii) contacting, in a second solvent, the product resulting from step b)i) with the methylaluminoxane.
50. The process of statement 45 or 46, wherein step b) comprises the sub-steps:
   bi) contacting, in a first solvent, the methylaluminoxane and the compound of formula (I) and/or formula (II), and
   bii) contacting, in a second solvent, the product resulting from step b)i) with the thermally-treated layered double hydroxide.
51. The process of any one of statements 48, 49 and 50, wherein the first and second solvents are identical or different,
52. The process of any one of statements 48 to 51, wherein the first and second solvents are independently selected from toluene, hexane, benzene, pentane and a mixture of two or more thereof.
53. The process of any one of statements 48 to 52, wherein the first and second solvents are toluene.
54. The process of any one of statements 45 to 53, wherein any one or more of the sub-steps of step b) is conducted at a temperature of 18-120° C.
55. The process of statement 54, wherein any one or more of the sub-steps of step b) is conducted at a temperature of 50-100° C.
56. The process of any one of statements 45 to 55, wherein any one or more of the sub-steps of step b) is conducted under the application of sonication.
57. The process of any one of statements 45 to 56, wherein the amount of MAO used in step b) is 30-70 wt % based on the mass of the layered double hydroxide pre-thermal treatment.
58. The process of any one of statements 45 to 57, wherein the amount of MAO used in step b) is 35-65 wt % based on the mass of the layered double hydroxide pre-thermal treatment.
59. The process of any one of statements 45 to 58, wherein the amount of MAO used in step b) is 35-45 wt % based on the mass of the layered double hydroxide pre-thermal treatment.
60. The process of any one of statements 45 to 59, wherein the amount of the compound of formula (I) and/or formula (II) used in step b) is 0.1-40 mol % relative to the number of moles of aluminium in the methylaluminoxane.
61. The process of any one of statements 45 to 60, wherein the amount of the compound of formula (I) and/or formula (II) used in step b) is 0.1-12.0 mol % relative to the number of moles of aluminium in the methylaluminoxane.
62. The process of any one of statements 45 to 61, wherein the amount of the compound of formula (I) and/or formula (II) used in step b) is 0.1-7.5 mol % relative to the number of moles of aluminium in the methylaluminoxane.
63. The process of any one of statements 45 to 62 wherein step b) comprises combining, in a single or multiple steps, the thermally-treated layered double hydroxide, the methylaluminoxane and the compound of formula (I) and/or formula (II) in quantities such that the solid support material comprises
   a) 50-70 wt % of layered double hydroxide and 30-50 wt % of methylaluminoxane relative to total mass of the solid support material, and
   b) 0.1-40 mol % of the compound of formula (I) and/or formula (II) relative to the number of moles of aluminium in the methylaluminoxane.
64. The process of any one of statements 45 to 63, wherein step a) comprises thermally treating a layered double hydroxide at a temperature of 120-200° C.
65. The process of any one of statements 45 to 64, wherein step a) comprises thermally treating a layered double hydroxide at a temperature of 150-250° C.
66. The process of any one of statements 45 to 65, wherein the compound of formula (I) and/or formula (II) is selected from perfluorophenol, tris-pentafluorophenyl borane and tetrafluorohydroquinone.
67. A solid support material obtainable by the process of any one of statements 45 to 66.
68. A catalytic composition comprising an olefin polymerisation catalyst supported on a solid support material as defined in any one of statements 1 to 44 and 67.
69. The catalytic composition of statement 68, wherein the olefin polymerisation catalyst has a structure according to formula (III) shown below:

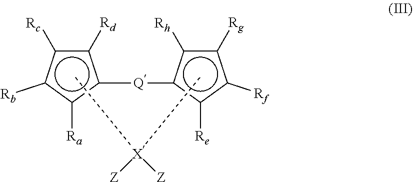

wherein
   Rₐ and R_{b} are each independently hydrogen or (1-2C)alkyl;
   R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
Q′ is absent (in which case each cyclopentadienyl ring is bound to hydrogen at this position), or is a bridging group selected from —CH₂— or —CH₂CH₂—, either or which may be optionally substituted with one or more groups selected from (1-4C)alkyl, (2-4C)alkenyl, (2-4C)alkynyl and aryl, or Q′ is a bridging group —Si(Rᵢ)(Rⱼ)—,
   wherein Rᵢ and Rⱼ are independently (1-4C)alkyl, (2-4C)alkenyl, (2-4C)alkynyl or aryl;
X′ is zirconium or hafnium; and
each Z group is independently selected from halo, hydrogen, (1-6C)alkyl, (1-6C)alkoxy, aryl or aryloxy, either or which is optionally substituted with one or more groups selected from (1-6C)alkyl and halo.
70. The catalytic composition of statement 68 or 69, wherein the olefin polymerisation catalyst has a structure according to formula (III) has any of the structures shown below:

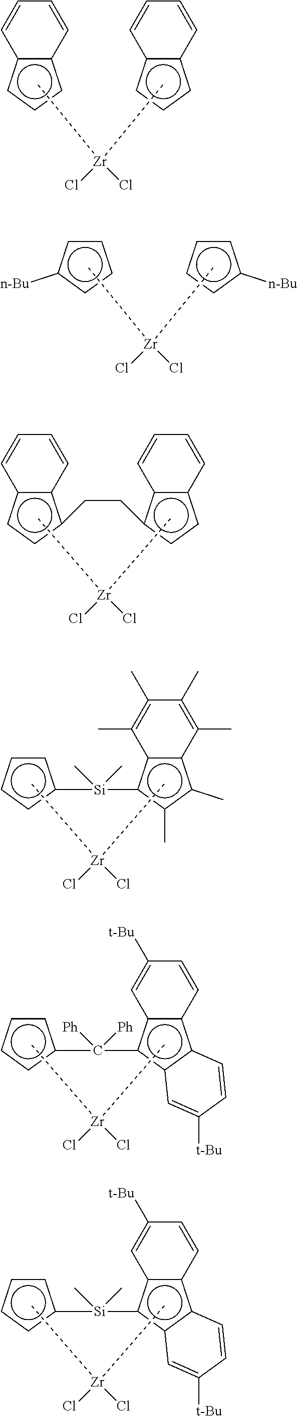

71. The catalytic composition of statement 68, 69 or 70, wherein the olefin polymerisation catalyst has a structure according to formula (III) has any of the structures shown below:

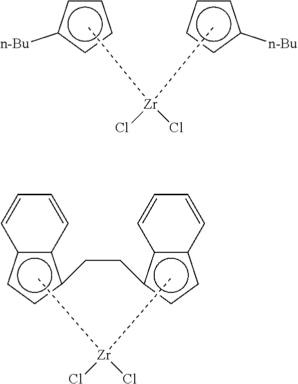

72. The catalytic composition of any one of statements 68 to 71, wherein [Al_{MAO}]/[X′] (i.e. the number of moles of Al in the methylaluminoxane of the solid support material divided by the number of moles of metal X′ in the olefin polymerisation catalyst having a structure according to formula (III)) is 50-250.
73. The catalytic composition of any one of statements 68 to 72, wherein [Al_{MAO}]/[X] is 75-225.
74. A process for the preparation of a polyolefin, the process comprising the step of:
   a) contacting olefin monomers with a catalytic composition as defined in any one of statements 68-73.
75. The process of statement 74, wherein the polyolefin is polyethylene and the olefin monomers are ethene molecules.
76. The process of statement 74, wherein the polyolefin is a copolymer and the olefin monomers are a mixture of monomers comprising 90-99 wt % ethene molecules and 1-10 wt % of one or more (4-8C) α-olefin.

### EXAMPLES

One or more examples of the invention will now be described, for the purpose of illustration only, with reference to the accompanying figure, in which:

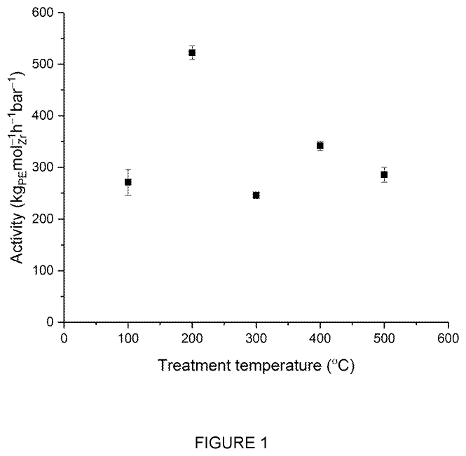

FIG. 1 shows the effect of the temperature of LDH thermal treatment under vacuum of Mg₃Al—CO₃-EtOH AMO-LDH on the polymerisation activity of LDHMMAO-(ⁿ BuCp)₂ZrCl₂. Error bars shown as the root mean square standard deviation.

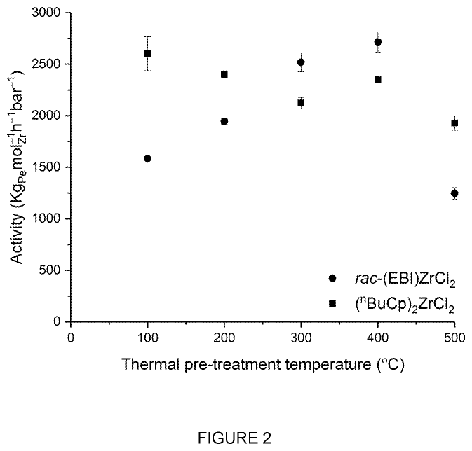

FIG. 2 shows the effect of the temperature of thermal treatment under vacuum of Mg₃Al—CO₃-EtOH AMO-LDH on the polymerisation activity of LDHMAO-(ⁿBuCp)₂ZrCl₂ and LDHMAO-rac-(EBI)ZrCl₂. Error bars shown as the root mean square standard deviation.

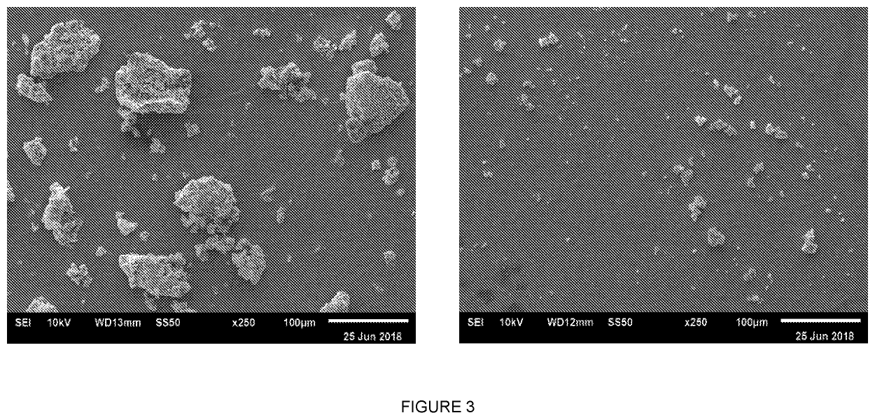

FIG. 3 shows SEM imaging of LDHMAO particles formed by swirling (left) or sonicating (right) Mg₃Al—CO₃-acetone AMO-LDH pre-treated at 150° C. under vacuum and MAO (40 wt % based on initial LDH mass) in toluene at 80° C. for 2 hours.

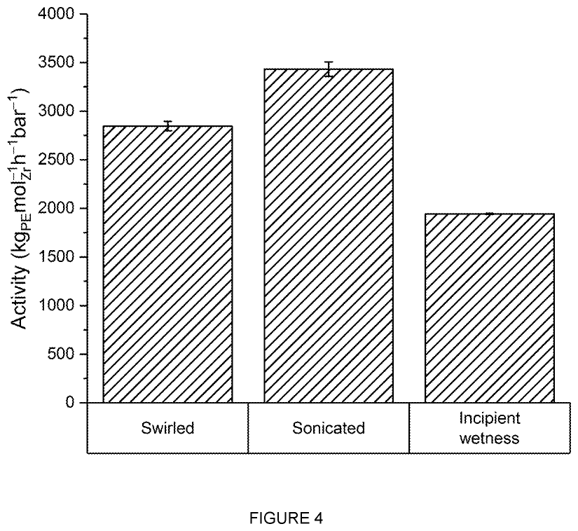

FIG. 4 shows the effect of the synthetic method on the polymerisation activity for catalysts based on Mg₃Al—CO₃-acetone AMO-LDH thermally pre-treated at 150° C. under vacuum, MAO (dried, 40 wt % based on initial LDH mass) and rac-(EBI)ZrCl₂ (Al/Zr=100) prepared by methods 5, 6 and 7 (Scheme 4). Error bars shown as the root mean square standard deviation.

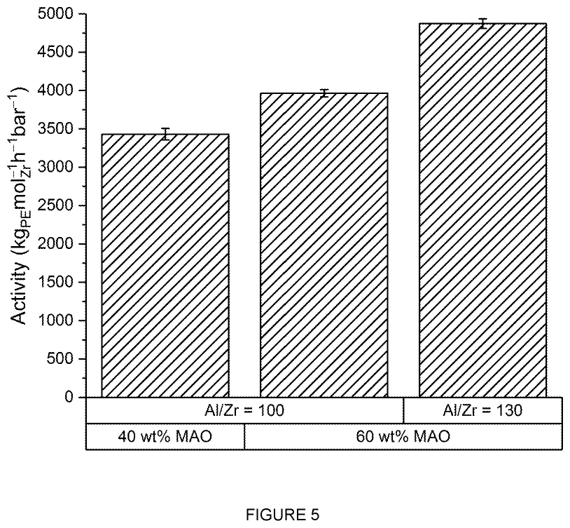

FIG. 5 shows the effect of increasing the MAO loading from 40 to 60 wt % based on the initial LDH mass and varying the Al:Zr ratio on the polymerisation activity for LDHMAO-rac-(EBI)ZrCl₂ catalyst, where LDHMAO was formed by sonication (Method 6). LDH=Mg₃Al—CO₃-acetone thermally pre-treated at 150° C. under vacuum for 6 hours. Error bars shown as the root mean square standard deviation.

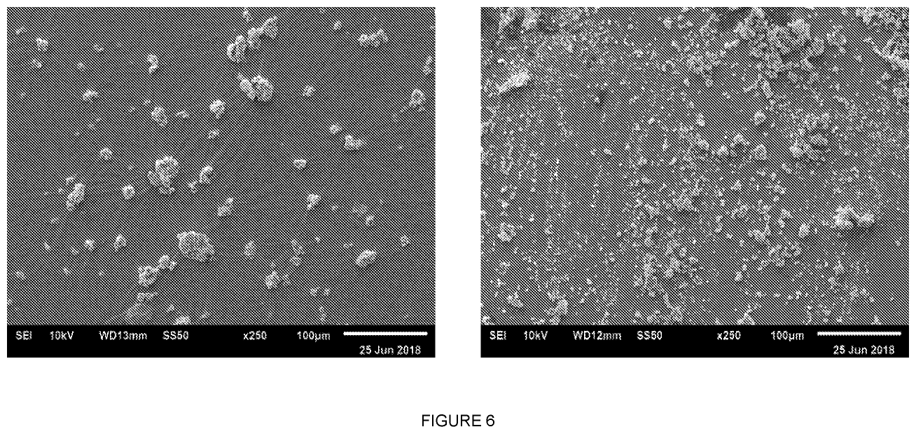

FIG. 6 shows SEM imaging of Mg₃Al—CO₃-acetone AMO-LDH particles pre-treated at 150° C. under vacuum either untreated (left) or having been sonicated for 1 hour in toluene (right).

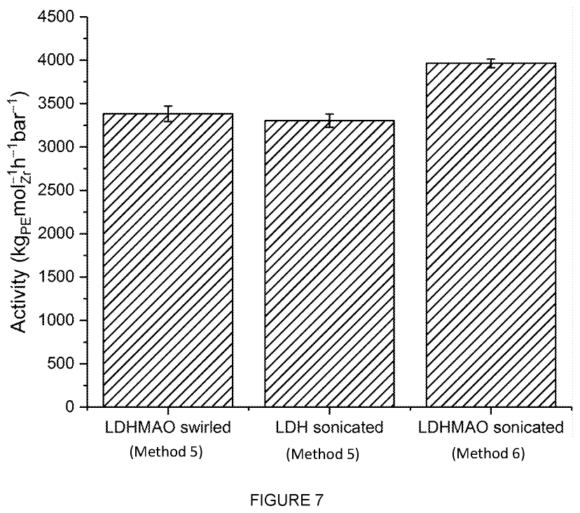

FIG. 7 shows the effect of the synthesis method with untreated or sonicated LDH particles on the polymerisation activity for LDHMAO-rac-(EBI)ZrCl₂ catalysts formed from Mg₃Al—CO₃-acetone AMO-LDH thermally pre-treated at 150° C. under vacuum for 6 hours, 60 wt % MAO and rac-(EBI)ZrCl₂ (Al/Zr=100). Error bars shown as the root mean square standard deviation.

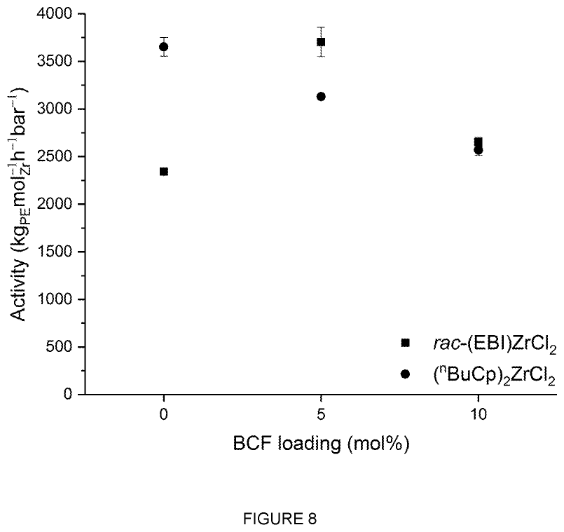

FIG. 8 shows the ethylene polymerisation activity of LDHMAOBCF based catalysts as a function of BCF loading (mol %). Error bars shown as the root mean square standard deviation.

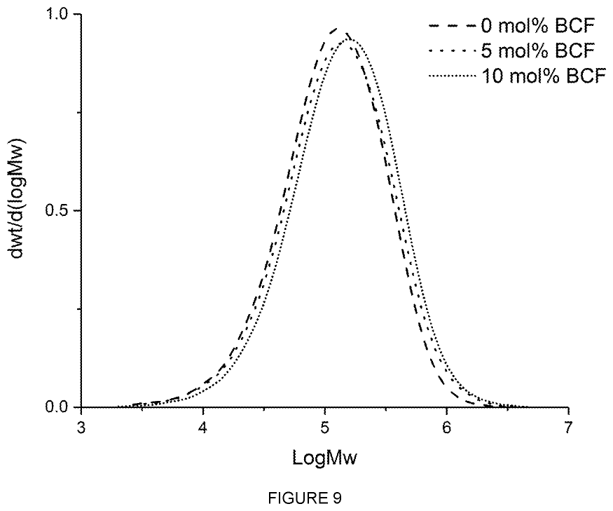

FIG. 9 shows the molecular weight distribution of the polymer produced by LDHMAOBCF-(ⁿBuCp)₂ZrCl₂ catalysts (0, 5, 10 mol % BCF loading).

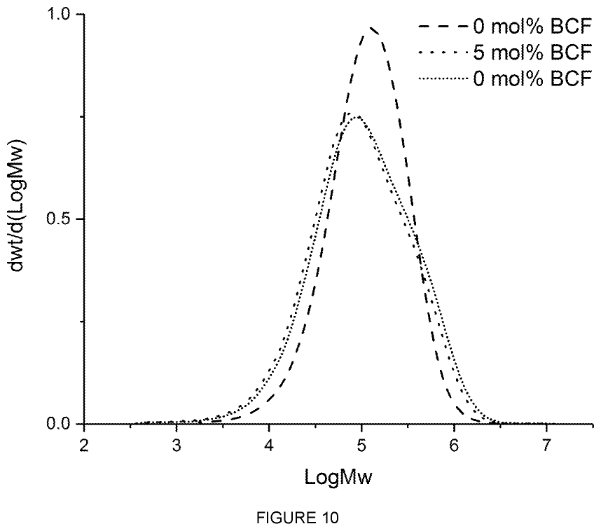

FIG. 10 shows the molecular weight distribution of the polymer produced by LDHMAOBCF-rac-(EBI)ZrCl₂ catalysts (0, 5, 10 mol % BCF loading).

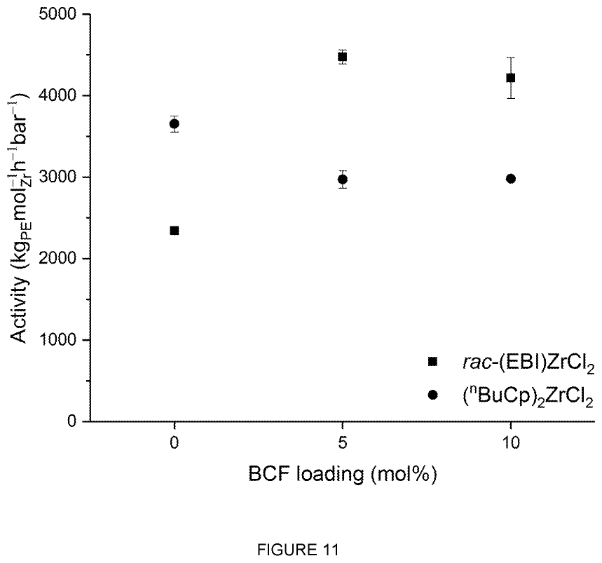

FIG. 11 shows the ethylene polymerisation activity of LDHMAOBCF based catalysts formed by heating at 80° C. during the modification as a function of BCF loading (mol %). Error bars shown as the root mean square standard deviation.

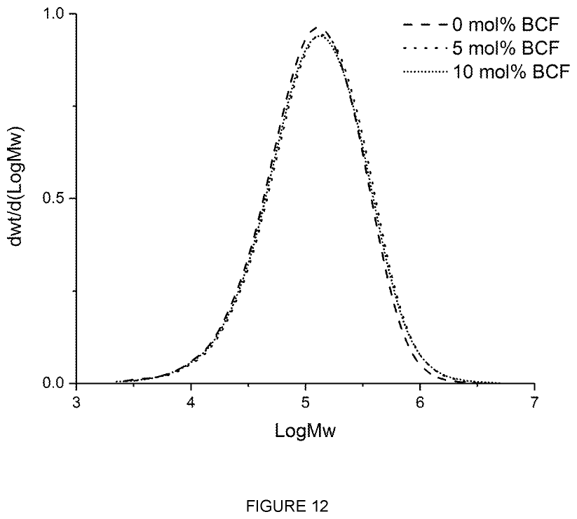

FIG. 12 shows the molecular weight distribution of the polymer produced by LDHMAOBCF-(ⁿBuCp)₂ZrCl₂ catalysts (0, 5, 10 mol % BCF loading).

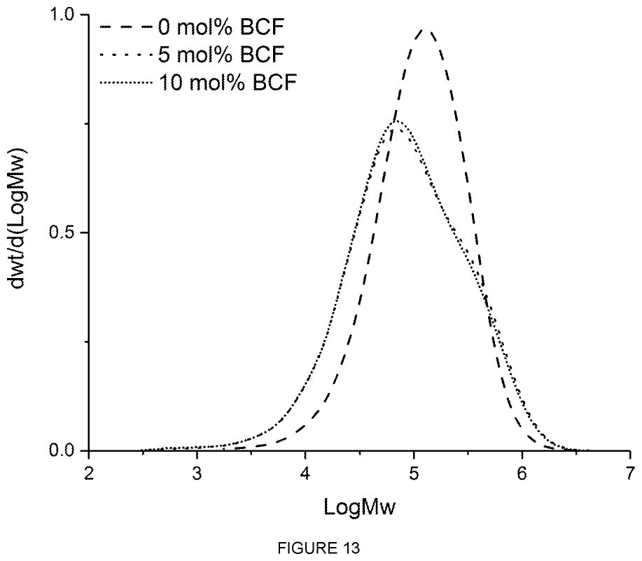

FIG. 13 shows the molecular weight distribution of the polymer produced by LDHMAOBCF-rac-(EBI)ZrCl₂ catalysts (0, 5, 10 mol % BCF loading).

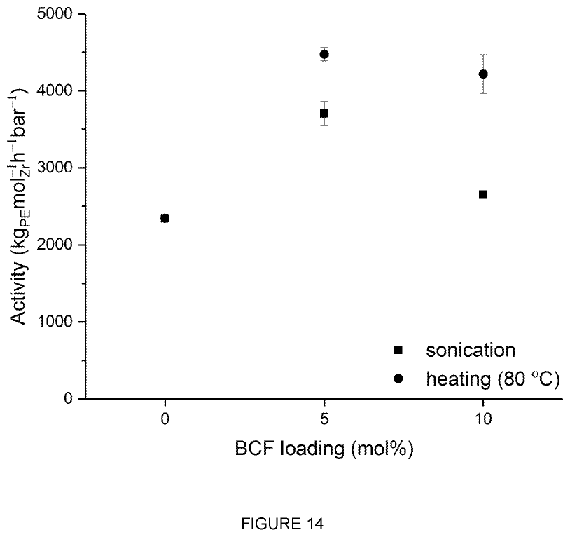

FIG. 14 shows a comparison between the ethylene polymerisation activity of LDHMAOBF-rac-(EBI)ZrCl₂ where the modification was performed either by sonicating or heating at 80° C. as a function of modifier loading (mol %). %). Error bars shown as the root mean square standard deviation.

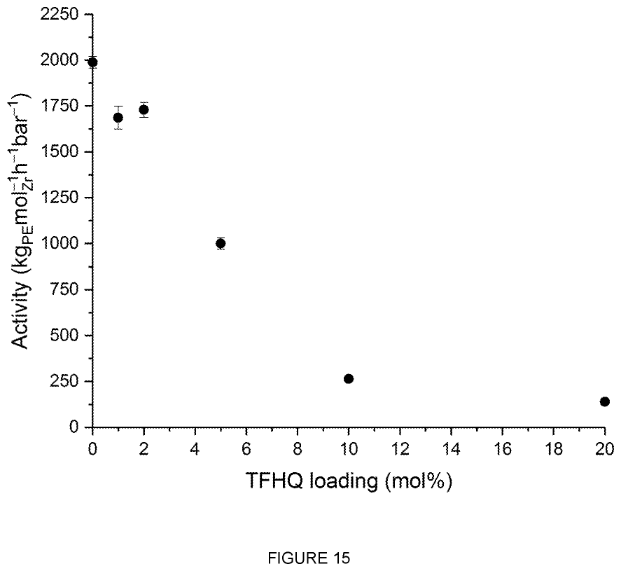

FIG. 15 shows the ethylene polymerisation activity of LDHMAOTFHQ-rac-(EBI)ZrCl₂ as a function of TFHQ loading (mol %). Error bars shown as the root mean squared standard deviation.

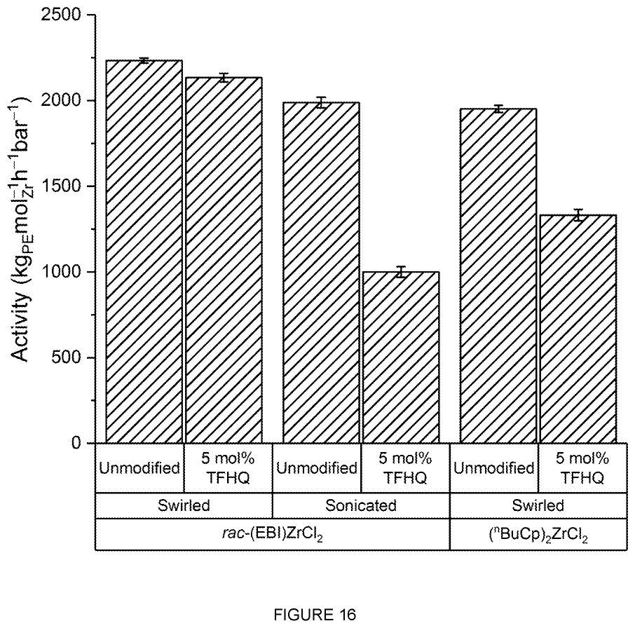

FIG. 16 shows a comparison between the ethylene polymerisation activity of TFHQ modified supports formed by swirling or sonication with their unmodified analogues for both (ⁿBuCp)₂ZrCl₂ and rac-(EBI)ZrCl₂ based catalyst systems. Error bars shown as the root mean squared standard deviation.

### PART A

### Example 1—Preparation of Solid Support Materials

### 1.1 Preparation of LDH Precursors

Following the procedure outlined in Chen, C.; Yang, M.; Wang, Q.; Buffet, J.-C.; O'Hare, D. Synthesis and Characterisation of Aqueous Miscible Organic-Layered Double Hydroxides. J. Mater. Chem. A 2014, 2 (36), 15102-15110, layered double hydroxides (LDHs) were synthesised by co-precipitation followed by AMO washing (acetone or ethanol). For the results presented here Mg₃Al—CO₃ and Mg₃Al-504 LDHs were utilised.

The LDH precursor (˜1 g) was loaded into a crucible and place inside a quartz tube that was sealed at one end. This was then connected to a vacuum/nitrogen manifold at the other and placed under dynamic vacuum (10⁻³ mbar). By utilising a tube furnace the sample could be heated to a desired temperature (100-500° C.) at a controlled ramp rate of 5° C. min⁻¹ at which it was held for six hours. After cooling, the tube was transferred to a nitrogen filled glovebox under static vacuum, where the dehydroxylated samples were stored in sealed vials.

### 1.2 Modification of LDH Precursors

The solid support materials were prepared by modification of the LDH precursors with methylaluminoxane (MAO) and an organic/organometallic modifier (namely B(C₆F₅)₃ or C₆F₅OH). The three reagents can be combined in multiple ways: prior reaction of the modifier with the LDH surface followed by treatment with MAO (Method 1), ‘one-pot’ combined reaction with modifier, MAO and the LDH (Method 2), prior modification of the MAO followed by impregnation on the LDH surface (Method 3), or finally, post modification of the LDHMAO support (Method 4).

The different synthetic protocols are outlined below in more detail:

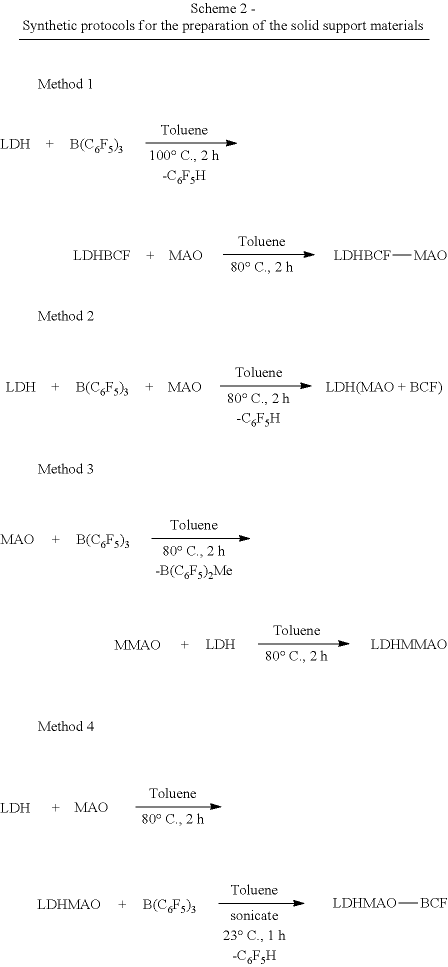

Reaction with the modifiers can be achieved by reaction in toluene utilising sonication, swirling, or heating and swirling usually over the course of 1 hour.

### Example 2—Preparation of Catalytic Compositions

The isolated solid support materials from Example 1 were reacted with (ⁿBuCp)₂ZrCl₂ or rac-(EBI)ZrCl₂ (shown below) in toluene at 60° C. for 1 hours. Addition of the solvent to the Schlenk flask yielded a pale yellow solution. Swirling with heating led to a gradual discolouration of the solution which ultimately became clear and colourless, indicative of complete immobilisation of the metallocene precursor. The resulting powders after drying were pale yellow

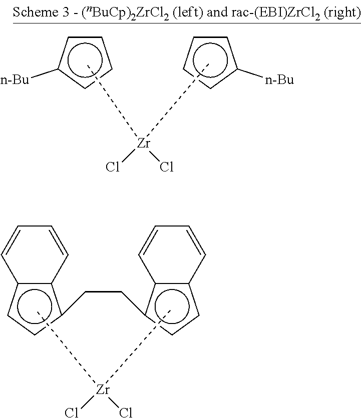

### Example 3—Polymerisation Studies

### 3.1 General Protocol for Polymerisation Experiments

TIBA (150 mg, 0.76 mmol) was dissolved in hexane (10 mL), added to a 100 mL Rotaflo ampoule and swirled to ensure no contaminants were present. Catalytic compositions of Example 2 (10 mg) were added and washed down with hexane (40 mL), after which the ampoule was sealed. Polymerisations were conducted on a specially designed vacuum/nitrogen manifold, with a separate ethylene feed that was dried through a column of activated molecular sieves. Prior to ethylene addition, all the tubing and headspace were cycled between vacuum and N2 three times, after which the internal atmosphere of the ampoule was evacuated and the tubing cycled between vacuum and ethylene 3 times. Polymerisations were conducted at 70° C., 2 bar ethylene with a stirring speed of 1000 rpm for 30 minutes. The resulting polyethylene was collected on a frit and washed with pentane (3×25 mL), before being dried under vacuum overnight at room temperature.

### 3.2 Effect of LDH Thermal Treatment on Polymerisation Activity

Using the procedure outlined in Example 1.1, Mg₃Al—CO₃-EtOH AMO-LDH was thermally treated for 6 hours under vacuum at 100, 200, 300, 400 and 500° C. and stored in a glovebox prior to use. Analysis of the materials shows an increase in the BET surface area and a decrease in the surface hydroxyl concentration with increased treatment temperature.

To see the effect of varying the pre-treatment temperature on the polymerisation activity, a commercially-available (Sigma Aldrich) modified MAO (termed “MMAO”), modified by replacement of some methyl groups with isobutyl or octyl groups, was grafted (at 40 wt %) onto the thermally treated Mg₃Al—CO₃-EtOH AMO-LDH surfaces at 80° C. in toluene for 2 hours, followed by (ⁿBuCp)₂ZrCl₂ (Al/Zr=50) at 60° C. for 1 hour in toluene. Polymerisations were conducted in duplicate in hexane at 70° C. utilising triisobutylaluminium (TIBA) as a scavenger, the results are shown in (FIG. 1 and Table 1).

TABLE 1
Effect of the temperature of LDH thermal treatment under
vacuum of Mg₃Al—CO₃—EtOH AMO-LDH on the polymer yield and
polymerisation activity of LDHMMAO-(ⁿBuCp)₂ZrCl₂.

| Treatment | PE | Activity |
|---|---|---|
| temperature (° C.) | (mg) | (kg_{PE}mol_{Zr}⁻¹h⁻¹bar⁻¹) |
| 100 | 239 | 271 ± 25 |
| 200 | 461 | 522 ± 13 |
| 300 | 217 | 246 ± 6 |
| 400 | 302 | 342 ± 9 |
| 500 | 252 | 286 ± 14 |

Mg₃Al═CO₃-EtOH AMO-LDH thermally treated under vacuum (6 hours) impregnated with 40 wt % MMAO, (ⁿBuCp)₂ZrCl₂ Al/Zr = 50, 10 mg catalyst loading (0.88 μmol_{Zr}), 2 bar ethylene, 50 mL hexane, 150 mg TIBA, 1000 rpm, 70° C., 0.5 hours. Error calculated as the root mean square standard deviation.

The activities of polymerisation range between 246 and 522 kg_{PE}mol_{Zr}⁻¹h⁻¹bar⁻¹, with a peak in activity observed at 200° C. A slight increase is observed at 400° C. compared to 300 and 500° C., which may be due to the increase in BET surface area between 300 and 400° C. (300 vs 361 m²g⁻¹) after loss of the layered LDH structure is seen to occur. Increase in surface area means the active sites are better dispersed and can lead to higher activity.

### 3.3 Effect of MAO Reagent on Polymerisation Activity

When compared with the use of the Sigma Aldrich MMAO (Example 3.2), employing unmodified MAOs supplied by Sigma Aldrich and Chemtura demonstrated an improvement in ethylene polymerisation activity. For example, the polymerisation activity of the LDHMAO-(ⁿBuCp)₂ZrCl₂ system (Mg₃Al—CO₃-EtOH AMO-LDH treated at 150° C., 40 wt % unmodified MAO, Al/Zr=50) was 1,271 kg_{PE}mol_{Zr}⁻¹h⁻¹ bar⁻¹ (Chemtura MAO) and 671 kg_{PE}mol_{Zr}⁻¹h⁻¹ bar⁻¹ (Sigma Aldrich MAO), whereas the activity of the analogous composition Sigma Aldrich MMAO (Example 3.2) was 497 kg_{PE}mol_{Zr}⁻¹h⁻¹bar⁻¹.

### 3.4 Effect of Modifier on Polymerisation Activity

The impact of modifiers on the activity was also tested for both (ⁿBuCp)₂ZrCl₂ and rac-(EBI)ZrCl₂ complexes immobilised on MAO (Sigma Aldrich) (Table 2). In both cases addition of 2.5 mol % of modifier (B(C₆F₅)₃ or C₆F₅OH) to LDHMAO at room temperature with sonication resulted in a solid support material exhibiting lower ethylene polymerisation activity when compared to the corresponding unmodified control (LDHMAO). For the (ⁿBuCp)₂ZrCl₂ catalyst, two modification methods with B(C₆F₅)₃ were employed; one where both the B(C₆F₅)₃ and MAO where mixed with LDH in toluene and heated at 80° C., so called LDH-(MAO+BCF) (Method 2 of Example 1.2), and one where B(C₆F₅)₃ was first reacted with the LDH surface at 80° C. for 2 hours in toluene and then MAO was impregnated under the same conditions, called LDHBCF-MAO (Method 1 of Example 1.1). For the former, a small increase in ethylene polymerisation activity within the error was observed.

TABLE 2
Effect on the polymer yield and polymerisation
activity of (ⁿBuCp)₂ZrCl₂ or rac-(EBI)ZrCl₂ supported
on LDHMAO modified with B(C₆F₅)₃ or C₆F₅OH.

| | | PE | Activity |
|---|---|---|---|
| Support | Zirconocene | (mg) | (kg_{PE}mol_{Zr}⁻¹h⁻¹bar⁻¹) |
| LDHMAO | (ⁿBuCp)₂ZrCl₂ | 473 | 497 ± 31 |
| | rac-(EBI)ZrCl₂ | 541 | 569 ± 25 |
| LDHMAO-BCF | (ⁿBuCp)₂ZrCl₂ | 417 | 438 ± 18 |
| | rac-(EBI)ZrCl₂ | 160 | 168 ± 12 |
| LDH-(MAO + BCF) | (ⁿBuCp)₂ZrCl₂ | 480 | 505 ± 20 |
| LDHBCF-MAO | (ⁿBuCp)₂ZrCl₂ | 323 | 339 ± 12 |
| LDHMAO-C₆F₅OH | (ⁿBuCp)₂ZrCl₂ | 104 | 110 ± 5 |
| | rac-(EBI)ZrCl₂ | 76 | 80 ± 7 |

Mg₃Al—CO₃—EtOH AMO-LDH thermally treated under vacuum (6 hours) at 150° C. impregnated with 40 wt % MAO (Sigma Aldrich), 2.5 mol % loading of modifier based on mol % aluminium from MAO, Al/Zr = 50, 10 mg catalyst loading (0.88 μmol_{Zr}), 2 bar ethylene, 50 mL hexane, 150 mg TIBA, 1000 rpm, 70° C., 0.5 hours. Error calculated as the root mean square standard deviation.

### PART B

### Example 4—Polymerisation Studies

### 4.1 Effect of LDH Thermal Treatment on Polymerisation Activity

Using the procedure outlined in Example 1.1, Mg₃Al—CO₃-EtOH AMO-LDH was thermally treated for 6 hours under vacuum at 100, 200, 300, 400 and 500° C. and stored in a glovebox prior to use. Analysis of the materials shows an increase in the BET surface area and a decrease in the surface hydroxyl concentration with increased treatment temperature.

To see the effect of varying the pre-treatment temperature on the polymerisation activity, MAO (Chemtura, 40 wt % based on initial LDH mass) was grafted onto the thermally treated Mg₃Al—CO₃-EtOH AMO-LDH surfaces at 80° C. in toluene for 2 hours, followed by either (ⁿBuCp)₂ZrCl₂ or rac-(EBI)ZrCl₂ (Al/Zr=100) at 60° C. for 1 hour in toluene. Polymerisations were conducted in duplicate in hexane (50 mL) at 70° C. for 30 minutes utilising triisobutylaluminium (TIBA, 150 mg) as a scavenger, the results are shown in (FIG. 2 and Table 3).

TABLE 3
Effect of the temperature of thermal treatment under vacuum of
Mg₃Al—CO₃—EtOH AMO-LDH on the polymer yield and polymerisation
activity of LDHMAO-(ⁿBuCp)₂ZrCl₂ and LDHMAO-rac-(EBI)ZrCl₂.

| Treatment | PE (g) | | Activity (kg_{PE}mol_{Zr}⁻¹h⁻¹bar⁻¹) | |
|---|---|---|---|---|
| temperature (° C.) | (ⁿBuCp)₂ZrCl₂ | rac-(EBI)ZrCl₂ | (ⁿBuCp)₂ZrCl₂ | rac-(EBI)ZrCl₂ |
| 100 | 1.26 | 0.76 | 2601 ± 165 | 1582 ± 18 |
| 200 | 1.16 | 0.94 | 2403 ± 32 | 1945 ± 28 |
| 300 | 1.02 | 1.22 | 2122 ± 56 | 2519 ± 91 |
| 400 | 1.13 | 1.31 | 2347 ± 10 | 2715 ± 98 |
| 500 | 0.93 | 0.60 | 1928 ± 70 | 1246 ± 56 |

Mg₃Al═CO₃—EtOH AMO-LDH thermally treated under vacuum (6 hours) impregnated with 40 wt % MAO, (ⁿBuCp)₂ZrCl₂ or rac-(EBI)ZrCl₂ (Al/Zr = 100), 10 mg catalyst loading, 2 bar ethylene, 50 mL hexane, 150 mg TIBA, 1000 rpm, 70° C., 0.5 hours. Error calculated as the root mean square standard deviation.

The two complexes supported on LDHMAO show differing trends in activity with respect to thermal pre-treatment temperature of the LDH precursor. For (ⁿBuCp)₂ZrCl₂, the activity slightly decreases across the temperature range but maintains fairly constant. In contrast, rac-(EBI)ZrCl₂ displays a steady increase in activity between 100 and 400° C., however a sharp drop in activity is observed at 500° C. This suggests that rac-(EBI)ZrCl₂ is more sensitive to changes in the support than (ⁿBuCp)₂ZrCl₂ appearing to favour a more dehydroxylated layered oxide based support.

### 4.2 Effect of Catalyst Synthesis Method on Polymerisation Activity

The catalyst preparation process was varied in an attempt to optimise the properties of the catalyst (Scheme 4).

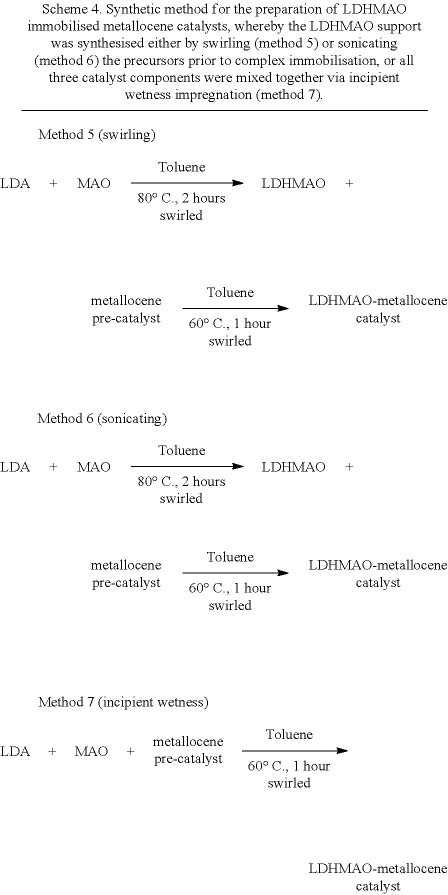

From SEM imaging of the LDHMAO particles formed from swirling LDH and MAO at 80° C. for 2 hours (Scheme 4, Method 5) it was seen that aggregation of particles occurred leading to a broad particle size distribution (FIG. 3). To see if a narrower size range and more even MAO coating of the particles could be obtained, sonication during the LDHMAO synthesis at 80° C. was attempted (Scheme 4, Method 6). From this method much smaller LDHMAO particles were obtained, suggesting that the MAO coating of sonicated particles inhibits particle aggregation.

In order to form the solid catalysts LDHMAO formed by swirling or sonicating was reacted with a metallocene pre-catalyst (Al/Zr=100) in toluene at 60° C. for 1 hour (Scheme 4, Methods 5 and 6). Alternatively, the solid catalyst was formed by incipient wetness impregnation whereby a mixture of LDH, MAO (40 wt % based on mass of LDH) and metallocenes pre-catalyst (Al/Zr=100) were heated at 60° C. for 1 hour with regular swirling (Scheme 4, Method 7). The resulting solid catalysts were tested for their slurry-phase ethylene polymerisation activity (Table 4 and FIG. 4).

TABLE 4
Effect of the synthetic method on the polymerisation activity
for catalysts based on Mg₃Al—CO₃-acetone AMO-LDH thermally
pre-treated at 150° C. under vacuum, MAO (dried, 40 wt %
based on initial LDH mass) and rac-(EBI)ZrCl₂ (Al/Zr =
100) prepared by methods 5, 6 and 7 (Scheme 4).

| Synthesis method | PE (g) | Activity (kg_{PE}mol_{Zr}⁻¹h⁻¹bar⁻¹) |
|---|---|---|
| 5 | 1.41 | 2846 ± 49 |
| 6 | 1.66 | 3431 ± 75 |
| 7 | 0.94 | 1944 ± 7 |

Mg₃Al—CO₃-acetone AMO-LDH thermally treated at 150° C. under vacuum (6 hours) impregnated with 40 wt % MAO, rac-(EBI)ZrCl₂ (Al/Zr = 100), 10 mg catalyst loading, 2 bar ethylene, 50 mL hexane, 150 mg TIBA, 1000 rpm, 70° C., 0.5 hours. Error calculated as the root mean square standard deviation.

From the activity data, the most active system is formed when the LDHMAO was sonicated during synthesis. This is believed to be due to the reduction in aggregation of particles, leading to a more even MAO coating and a greater particle surface area.

To further try and enhance the activity of the LDHMAO system formed by sonication (Method 6), the MAO loading was increased to 60 wt % based on the initial based of LDH. Two different metallocene pre-catalyst loadings were utilised and compared to the solid catalyst formed with 40 wt % MAO. The first loading maintained an Al:Zr of 100, whilst the second compared the activity when the molar loading of zirconium in the final catalyst was the same (0.48 pmolzᵣ in 10 mg of catalyst). Increasing the MAO loading to 60 wt % leads to an increase in the activity of the system (FIG. 5 and Table 5). Moreover, maintaining the same zirconium loading in the same final catalyst (Al/Zr=130 for 60 wt % MAO support), leads to a greater enhancement in activity, 1.42 times that of the 40 wt % support.

TABLE 5
Effect of increasing the MAO loading from 40 to 60 wt % based
on the initial LDH mass and varying the Al:Zr ratio on the polymerisation
activity for LDHMAO-rac-(EBI)ZrCl₂ catalyst, where LDHMAO
was formed by sonication (Method 6).

| MAO loading | | | Activity |
|---|---|---|---|
| (wt %) | Al/Zr | PE (g) | (kg_{PE}mol_{Zr}⁻¹h⁻¹bar⁻¹) |
| 40 | 100 | 1.66 | 3431 ± 75 |
| 60 | 100 | 2.51 | 3964 ± 49 |
| 60 | 130 | 2.36 | 4873 ± 61 |

Mg₃Al═CO₃-acetone AMO-LDH thermally treated at 150° C. under vacuum (6 hours) impregnated by sonication with either 40 or 60 wt % MAO, rac-(EBI)ZrCl₂ (Al/Zr = 100 or 130), 10 mg catalyst loading, 2 bar ethylene, 50 mL hexane, 150 mg TIBA, 1000 rpm, 70° C., 0.5 hours. Error calculated as the root mean square standard deviation.

As controls, the LDHMAO-rac-(EBI)ZrCl₂ systems with 60 wt % MAO were also synthesised by swirling during the LDHMAO synthesis (Method 5) using the thermally pre-treated LDH either as is or having sonicated it for 1 hour in toluene to see if this would reduce particle aggregation. SEM imaging of the thermally pre-treated LDH with and without sonication showed that particle aggregation was reduced to some extent by sonication but a broad particle size distribution was still observed (FIG. 6).

For the catalysts synthesised by swirling during the LDHMAO synthesis (Method 5) with 60 wt % MAO, the activities increased (FIG. 7 and Table 6) compared to the 40 wt % MAO catalyst formed from method 5 (FIG. 4 and Table 4). There is very little difference in activity between the sonicated and untreated LDH, however both are lower than the catalyst formed by method 6. This could be due to aggregation of the sonicated LDH particles after drying, which may be inhibited by method 6 due to the MAO coating on the surface.

TABLE 6
Effect of the synthesis method with untreated or
sonicated LDH particles on the polymerisation
activity for LDHMAO-rac-(EBI)ZrCl₂ catalysts
formed from Mg₃Al═CO₃-acetone AMO-LDH thermally
pre-treated at 150° C. under vacuum for 6 hours,
60 wt % MAO and rac-(EBI)ZrCl₂ (Al/Zr = 100).

| | Synthesis | | Activity |
|---|---|---|---|
| LDH | method | PE (g) | (kg_{PE}mol_{Zr}⁻¹h⁻¹bar⁻¹) |
| Untreated | 5 | 2.14 | 3382 ± 89 |
| Sonicated | 5 | 2.09 | 3303 ± 76 |
| Untreated | 6 | 2.51 | 3964 ± 49 |

Mg₃Al—CO₃-acetone AMO-LDH thermally treated at 150° C. under vacuum (6 hours) either untreated or sonicated for 1 hour in toluene, impregnated by either with swirling or sonication with 60 wt % MAO, rac-(EBI)ZrCl₂ (Al/Zr = 100), 10 mg catalyst loading, 2 bar ethylene, 50 mL hexane, 150 mg TIBA, 1000 rpm, 70° C., 0.5 hours. Error calculated as the root mean square standard deviation.

### 4.2 Effect of Modifier on Polymerisation Activity

LDHMAO was synthesised by swirling (Method 5) Mg₃Al—CO₃-acetone AMO-LDH thermally pre-treated at 150° C. under vacuum for 6 hours and Chemtura MAO (40 wt % based on the initial mass of LDH).

4.2.1 Tris-pentafluorophenyl Borane (B(C₆F₅)₃ or BCF)

Tris-pentafluorophenyl borane (B(C₆F₅)₃ or BCF) was reacted with the LDHMAO by room temperature sonication in toluene for 1 hour. The solid was filtered, washed with toluene (2×20 mL) followed by hexane (2×20 mL) and dried. The BCF loading was varied from 5 to 10 mol % based on the aluminium present in the MAO. The resulting LDHMAOBCF was reacted with either (ⁿBuCp)₂ZrCl₂ or rac-(EBI)ZrCl₂ (Al/Zr=100) at 60° C. for 1 hour in toluene. Solid catalysts were isolated by filtration of the clear and colourless toluene solution followed by drying under vacuum. The ethylene polymerisation activities of the catalysts are shown in FIG. 8 and Table 7. The rac-(EBI)ZrCl₂ system shows an increase in activity at 5 and 10 mol % BCF loading compared to the control.

TABLE 7
Ethylene polymerisation activity of LDHMAOBCF based
catalysts as a function of BCF loading (mol %).

| BCF loading | PE (g) | | Activity (kg_{PE}mol_{Zr}⁻¹h⁻¹bar⁻¹) | |
|---|---|---|---|---|
| (mol %) | (ⁿBuCp)₂ZrCl₂ | rac-(EBI)ZrCl₂ | (ⁿBuCp)₂ZrCl₂ | rac-(EBI)ZrCl₂ |
| 0 | 1.77 | 1.14 | 3653 ± 98 | 2342 ± 25 |
| 5 | 1.52 | 1.81 | 3130 ± 22 | 3703 ± 155 |
| 10 | 1.24 | 1.29 | 2567 ± 54 | 2650 ± 49 |

Mg₃Al—CO₃-acetone AMO-LDH thermally treated at 150° C. under vacuum (6 hours), impregnated with 40 wt % MAO, BCF (0, 5 or 10 mol %) and (ⁿBuCp)₂ZrCl₂ or rac-(EBI)ZrCl₂ (Al/Zr = 100), 10 mg catalyst loading, 2 bar ethylene, 50 mL hexane, 150 mg TIBA, 1000 rpm, 70° C., 0.5 hours. Error calculated as the root mean square standard deviation.

Gel permeation chromatography (GPC) traces of the polymer produced showed a marked difference between the (ⁿBuCp)₂ZrCl₂ and rac-(EBI)ZrCl₂ based systems (FIGS. 9 and 10 and Tables 8 and 9). For the (ⁿBuCp)₂ZrCl₂ a small increase is observed in the number average molecular weights for the polymer as the BCF loading is increased whilst maintaining narrow polydispersity. For the rac-(EBI)ZrCl₂ based catalysts an increase in molecular weight is observed with increased BCF loading, however the GPC trace appears to be bimodal, with broad PDI values suggesting the catalyst is no longer single-site in nature.

TABLE 8
Number average molecular weight (Mw), number average
molecular number (Mn) and polydispersity (PDI) values for
the polymer produced by LDHMAOBCF-(ⁿBuCp)₂ZrCl₂ catalysts
(0, 5, 10 mol % BCF loading).

| BCF loading (%) | Mw (gmol⁻¹) | Mn (gmol⁻¹) | PDI (Mw/Mn) |
|---|---|---|---|
| 0 | 176300 | 66900 | 2.6 |
| 5 | 203100 | 71100 | 2.9 |
| 10 | 225100 | 80900 | 2.8 |

TABLE 9
Number average molecular weight (Mw), number
average molecular number (Mn) and polydispersity (PDI) values
for the polymer produced by LDHMAOBCF-rac-(EBI)ZrCl₂
catalysts (0, 5, 10 mol % BCF loading).

| BCF loading (%) | Mw (gmol⁻¹) | Mn (gmol⁻¹) | PDI (Mw/Mn) |
|---|---|---|---|
| 0 | 174200 | 64700 | 2.7 |
| 5 | 187500 | 37200 | 5.0 |
| 10 | 213300 | 41000 | 5.2 |

To try and quantify the BCF loading in each case the rac-(EBI)ZrCl₂ based catalysts were analysed by ICP-MS (Table 10). With increased BCF loading the aluminium weight percent in the LDHMAO and final catalysts are expected to decrease. A theoretical Al wt % can be calculated by assuming transfer of one C₆F₅ group per mole of BCF. From the results it can be seen that the Al wt % does decrease with increased BCF loadings, however the results suggest that either more than one equivalent of C₆F₅ is transferred per mole of BCF or that some of the borane may immobilise on the surface.

TABLE 10
ICP-MS analysis of AMO-LDH, thermally treated AMO-LDH, LDHMAO, BCF modified
LDHMAOs (5 and 10 mol %) and the catalysts formed with rac-(EBI)ZrCl₂.

| | | BCF | | | |
|---|---|---|---|---|---|
| | Theoretical | loading | | Calculated | |
| Material | MAO wt % Al | (mol %) | Mg/Al | MAO wt % Al | Al/Zr |
| Mg_{2.87}Al—CO₃-acetone | N/A | N/A | 2.87 | N/A | N/A |
| AMO-LDH | | | | | |
| (Mg_{2.98}Al—CO₃-acetone)150° C. | N/A | N/A | 2.98 | N/A | N/A |
| LDHMAO | 13.3 | 0 | 1.13 | 13.2 | N/A |
| LDHMAOBCF | 12.8 | 5 | 1.16 | 11.5 | N/A |
| LDHMAOBCF | 12.4 | 10 | 1.16 | 11.9 | N/A |
| LDHMAO-rac-(EBI)ZrCl₂ | 13.1 | 0 | 1.14 | 10.1 | 82.0 |
| LDHMAOBCF-rac-(EBI)ZrCl₂ | 12.7 | 5 | 1.15 | 11.8 | 94.7 |
| LDHMAOBCF-rac-(EBI)ZrCl₂ | 12.2 | 10 | 1.15 | 12.1 | 119.3 |

Digestions performed in 2.5 mL conc. HNO₃ at 60° C. for 2 hours, followed by two 100-fold dilutions with DI water.

Catalysts were synthesised by reaction of LDHMAO and BCF (0, 5 and 10 mol %) in toluene at 80° C. for 1 hour with regular swirling followed by immobilisation of either (ⁿBuCp)₂ZrCl₂ or rac-(EBI)ZrCl₂ (Al/Zr=100) at 60° C. for 1 hour in toluene. In analogy to the sonicated support, the rac-(EBI)ZrCl₂ based catalysts activity is again seen to increase with increased loading (FIG. 11 and Table 11), and this increase is maintained at 10 mol % BCF loading. The peak activity at 5 mol % is 1.9 times more active than the control.

TABLE 11
Ethylene polymerisation activity of LDHMAOBCF based catalysts formed by heating
at 80° C. during the modification as a function of BCF loading (mol %).

| BCF loading | PE (g) | | Activity (kg_{PE}mol_{Zr}⁻¹h⁻¹bar⁻¹) | |
|---|---|---|---|---|
| (mol %) | (ⁿBuCp)₂ZrCl₂ | rac-(EBI)ZrCl₂ | (ⁿBuCp)₂ZrCl₂ | rac-(EBI)ZrCl₂ |
| 0 | 1.77 | 1.14 | 3653 ± 98 | 2342 ± 25 |
| 5 | 1.44 | 2.19 | 2972 ± 106 | 4475 ± 86 |
| 10 | 1.44 | 2.06 | 2980 ± 11 | 4217 ± 251 |

Mg₃Al—CO₃-acetone AMO-LDH thermally treated at 150° C. under vacuum (6 hours), impregnated with 40 wt % MAO, BCF (0, 5 or 10 mol %) and (ⁿBuCp)₂ZrCl₂ or rac-(EBI)ZrCl₂ (Al/Zr = 100). 10 mg catalyst loading, 2 bar ethylene, 50 mL hexane, 150 mg TIBA, 1000 rpm, 70° C., 0.5 hours. Error calculated as the root mean square standard deviation.

Gel permeation chromatography (GPC) traces of the polymer produced by the (ⁿBuCp)₂ZrCl₂ and rac-(EBI)ZrCl₂ based systems are analogous to those observed when the LDHMAOBCF support was sonicated during modification (FIGS. 12 and 13 and Tables 12 and 13). For the (ⁿBuCp)₂ZrCl₂ a small increase is observed in the number average molecular weights for the polymer as the BCF loading is increased whilst maintaining narrow polydispersity. For the rac-(EBI)ZrCl₂ based catalysts an increase in molecular weight is observed with increased BCF loading, however the GPC trace appears to be bimodal, with broad PDI values suggesting the catalyst is no longer single-site in nature.

TABLE 12
Number average molecular weight (Mw), number average
molecular number (Mn) and polydispersity (PDI) values for
the polymer produced by LDHMAOBCF-(ⁿBuCp)₂ZrCl₂ catalysts
(0, 5, 10 mol % BCF loading).

| BCF loading (%) | Mw (gmol⁻¹) | Mn (gmol⁻¹) | PDI (Mw/Mn) |
|---|---|---|---|
| 0 | 176300 | 66900 | 2.6 |
| 5 | 197300 | 71400 | 2.8 |
| 10 | 195300 | 68900 | 2.8 |

TABLE 13
Number average molecular weight (Mw), number
average molecular number (Mn) and polydispersity (PDI) values
for the polymer produced by LDHMAOBCF-rac-(EBI)ZrCl₂
catalysts (0, 5, 10 mol % BCF loading).

| BCF loading (%) | Mw (gmol⁻¹) | Mn (gmol⁻¹) | PDI (Mw/Mn) |
|---|---|---|---|
| 0 | 174200 | 64700 | 2.7 |
| 5 | 179000 | 33300 | 5.4 |
| 10 | 171900 | 31800 | 5.4 |

Comparison of the activity between the LDHMAOBCF-rac-(EBI)ZrCl₂ catalysts formed either by sonicating or swirling during the modification step (FIG. 14), shows that the heated sample displays increased activity at both 5 and 10 mol % BCF loading compared to the sonicated support. The peak activity at 5 mol % BCF loading is 1.2 times more active than the sonicated analogue.

### 4.2.2 Tetrafluorohydroquinone (TFHQ)

LDHMAO and tetrafluorohydroquinone (TFHQ) (0, 1, 2, 5, 10 and 20 mol %) were sonicated in toluene at room temperature for 1 hour followed by filtration, washing with toluene (2×20 mL) and drying in vacuo. The resulting LDHMAOTFHQ supports were reacted with rac-(EBI)ZrCl₂ (Al/Zr=100) in toluene at 60° C. for 1 hour after which the supernatant was removed by filtration and the solid dried. The activity towards ethylene polymerisation of the resulting catalysts are shown in FIG. 15 and Table 14. As the amount of modifier in the system is increased the ethylene polymerisation activity is seen to decrease.

TABLE 14
Ethylene polymerisation activity of LDHMAOTFHQ-rac-
(EBI)ZrCl₂ as a function of TFHQ loading (mol %).

| TFHQ loading (mol %) | PE (mg) | Activity (kg_{PE}mol_{Zr}⁻¹h⁻¹bar⁻¹) |
|---|---|---|
| 0 | 960 | 1989 ± 32 |
| 1 | 808 | 1687 ± 62 |
| 2 | 823 | 1729 ± 41 |
| 5 | 466 | 1000 ± 31 |
| 10 | 119 | 263 ± 4 |
| 20 | 59 | 139 ± 3 |

Mg₃Al—CO₃-acetone AMO-LDH thermally treated at 150° C. under vacuum (6 hours), impregnated with 40 wt % MAO, TFHQ (0, 1, 2, 5, 10, 20 mol %) and rac-(EBI)ZrCl₂ (Al/Zr = 100). 10 mg catalyst loading, 2 bar ethylene, 50 mL hexane, 150 mg TIBA, 1000 rpm, 70° C., 0.5 hours. Error calculated as the root mean square standard deviation.

To see if sonication during the modification system was detrimental to the system the modification was also performed with 5 mol % TFHQ by regular swirling at room temperature. Catalyst systems based on (ⁿBuCp)₂ZrCl₂ and rac-(EBI)ZrCl₂ were synthesised and compared to the unmodified systems (FIG. 16 and Table 15). The activity of the modified support formed by swirling is much higher than when sonication was employed, which may be due to sonication breaking up LDHMAO aggregates exposing unreacted hydroxyl groups which then deactivate the metallocenes pre-catalyst. However, for both (ⁿBuCp)₂ZrCl₂ and rac-(EBI)ZrCl₂ the TFHQ modified supports are less active than the unmodified analogue.

TABLE 15
Comparison between the ethylene polymerisation activity of TFHQ modified
supports formed by swirling or sonication with their unmodified analogues for
both (ⁿBuCp)₂ZrCl₂ and rac-(EBI)ZrCl₂ based catalyst systems.

| Modification | TFHQ loading | Metallocene | | Activity |
|---|---|---|---|---|
| method | (mol %) | pre-catalsyt | PE (g) | (kg_{PE}molzᵣ⁻¹h⁻¹bar⁻¹) |
| Swirled | 0 | (ⁿBuCp)₂ZrCl₂ | 0.94 | 1951 ± 21 |
| Swirled | 5 | (ⁿBuCp)₂ZrCl₂ | 0.62 | 1331 ± 33 |
| Swirled | 0 | rac-(EBI)ZrCl₂ | 1.08 | 2233 ± 14 |
| Swirled | 5 | rac-(EBI)ZrCl₂ | 0.99 | 2134 ± 25 |
| Sonicated | 0 | rac-(EBI)ZrCl₂ | 0.96 | 1989 ± 32 |
| Sonicated | 5 | rac-(EBI)ZrCl₂ | 0.47 | 1000 ± 31 |

Mg₃Al—CO₃-acetone AMO-LDH thermally treated at 150° C. under vacuum (6 hours), impregnated with 40 wt % MAO, TFHQ (0 or 5 mol %) and (ⁿBuCp)₂ZrCl₂ or rac-(EBI)ZrCl₂ (Al/Zr = 100). 10 mg catalyst loading, 2 bar ethylene, 50 mL hexane, 150 mg TIBA, 1000 rpm, 70° C., 0.5 hours. Error calculated as the root mean square standard deviation.

While specific embodiments of the invention have been described herein for the purpose of reference and illustration, various modifications will be apparent to a person skilled in the art without departing from the scope of the invention as defined by the appended claims.

1. A solid support material suitable for supporting an olefin polymerisation catalyst, the solid support material comprising:
a) a layered double hydroxide;
b) a methylaluminoxane associated with the layered double hydroxide; and
c) a compound or moiety having a structure according to formula (I) and/or (II) shown below: 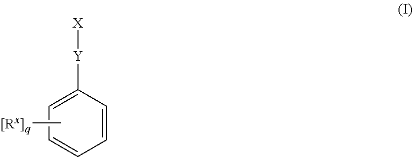
wherein
X represents a portion of the layered double hydroxide or the methylaluminoxane, or
X is hydrogen, halo, hydroxyl or aryl optionally substituted with one or more groups selected from halo, hydroxyl, (1-4C)alkyl, (2-4C)alkenyl, (2-4C)alkynyl and (1-4C)haloalkyl;
Y is O, B(Q) or Al(Q)
wherein Q is halo, hydroxyl or aryl optionally substituted with one or more groups selected from halo, hydroxyl, (1-4C)alkyl, (2-4C)alkenyl, (2-4C)alkynyl and (1-4C)haloalkyl;
each R^{x} is independently selected from halo, hydroxyl, (1-4C)alkyl, (2-4C)alkenyl, (2-4C)alkynyl and (1-4C)haloalkyl,
and/or two adjacent groups R^{x} are linked, such that, when taken in combination with the atoms to which they are attached, they form a 6-membered aromatic ring that is optionally substituted with one or more groups selected from halo, hydroxyl, (1-4C)alkyl, (2-4C)alkenyl, (2-4C)alkynyl and (1-4C)haloalkyl; and
q is 0 to 5; 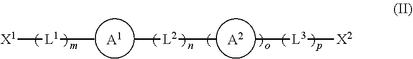
wherein
X¹ and X² are independently selected from OH, COOH, SH, PR^{v}R^{w}H and NR^{v}H, or their deprotonated forms;
rings A¹ and A² are independently aromatic or heteroaromatic, and are optionally substituted with one or more groups R¹ selected from OH, COOH, NR^{v}R^{w}, halo, (1-5C)alkyl, (2-5C)alkenyl, (2-5C)alkynyl, (1-5C)alkoxy, aryl and heteroaryl;
L¹, L² and L³ are independently selected from (1-5C)alkylene and phenylene, and are optionally substituted with one or more groups selected from OH, halo, (1-3C)alkyl and (1-3C)haloalkyl;
R^{v} and R^{w} are independently selected from hydrogen and (1-4C)alkyl;
m is 0 or 1;
n is 0 or 1;
o is 0 or 1; and
p is 0 or 1.

2. The solid support material of claim 1 or 2, wherein X represents a portion of the layered double hydroxide or the methylaluminoxane, or X is perfluorophenyl or hydrogen.

3. The solid support material of claim 1, 2 or 3, wherein Y is O or B(Q).

4. The solid support material of any preceding claim, wherein Q is selected from chloro, hydroxyl or phenyl optionally substituted with one or more groups selected from chloro, fluoro, hydroxyl, (1-4C)alkyl and (1-4C)haloalkyl.

5. The solid support material of any preceding claim, wherein Q is perfluorophenyl.

6. The solid support material of any preceding claim, wherein each R^{x} is independently selected from chloro, fluoro, hydroxyl, (1-4C)alkyl and (1-4C)fluoroalkyl.

7. The solid support material of any preceding claim, wherein all R^{x} groups are identical.

8. The solid support material of any preceding claim, wherein all R^{x} groups are fluoro.

9. The solid support material of any preceding claim, wherein q is 1, 2 or 5.

10. The solid support material of any preceding claim, wherein
X represents a portion of the layered double hydroxide or the methylaluminoxane, or X is perfluorophenyl or hydrogen;
Y is O or B(Q);
Q is phenyl substituted with one or more groups selected from chloro and fluoro;
each R^{x} is independently selected from chloro and fluoro; and
q is 1, 2 or 5.

11. The solid support material of any preceding claim, wherein the modifying compound or moiety having a structure according to formula (I) has any one or more of the following structures:

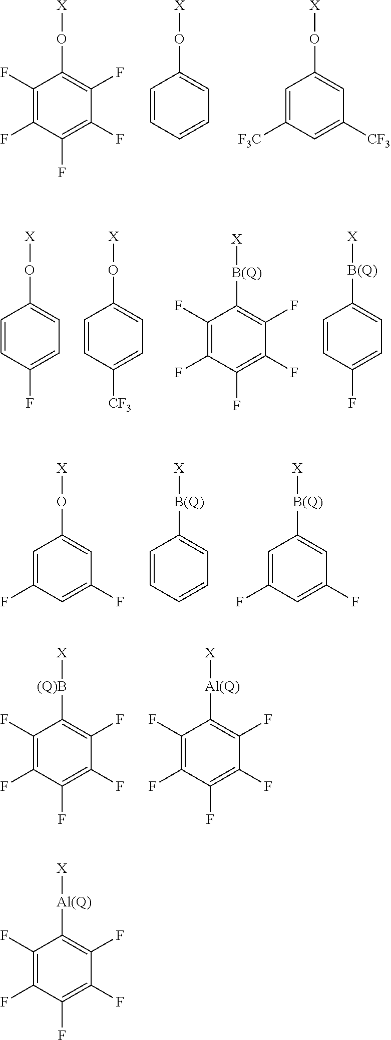

12. The solid support material of any preceding claim, wherein the modifying compound or moiety having a structure according to formula (I) has any one or more of the following structures: 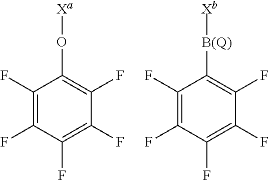
wherein
X^{a} represents a portion of the layered double hydroxide or the methylaluminoxane, or X^{a} is hydrogen;
X^{b} represents a portion of the layered double hydroxide or the methylaluminoxane, or X^{b} is perfluorophenyl; and
Q is perfluorophenyl.

13. The solid support material of any preceding claim, wherein the modifying compound or moiety of formula (II) has any one or more of the following structures: 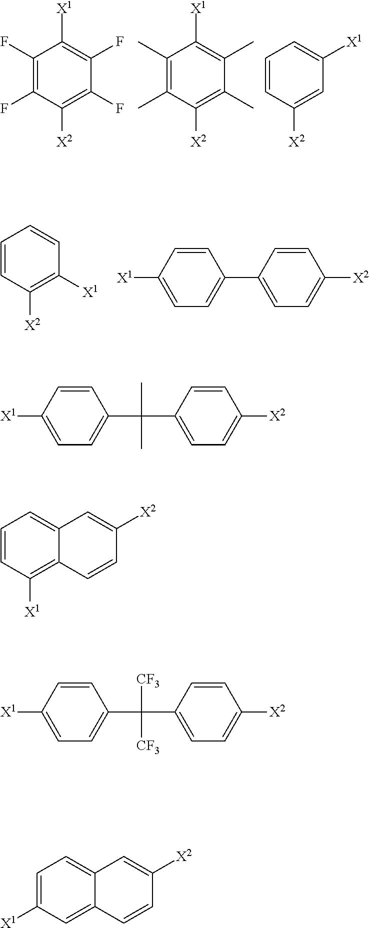
wherein X¹ and X² are OH, or its deprotonated form.

14. The solid support material of any preceding claim, wherein the modifying compound or moiety of formula (II) has any one or more of the following structures: 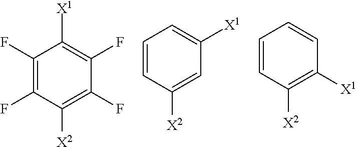
wherein X¹ and X² are OH, or its deprotonated form.

15. The solid support material of any preceding claim, wherein the solid support material comprises 50-70 wt % of layered double hydroxide and 30-50 wt % of methylaluminoxane relative to the total mass of the solid support material.

16. The solid support material of any preceding claim, wherein the solid support material comprises 0.1-12.0 mol % of the compound of formula (I) and/or formula (II) relative to the number of moles of aluminium in the methylaluminoxane.

17. The solid support material of any preceding claim, wherein the layered double hydroxide is a Mg/Al, Ca/Al, Ni/Al, Cu/Al or a Zn/Al layered double hydroxide.

18. The solid support material of any preceding claim, wherein the layered double hydroxide comprises at least one anion selected from carbonate, nitrate, nitrite and sulphate.

19. The solid support material of any preceding claim, wherein the layered double hydroxide is a magnesium aluminium carbonate layered double hydroxide.

20. A process for the preparation of a solid support material as defined in any preceding claim, the process comprising the steps of:
a) thermally treating a layered double hydroxide at a temperature of 100-500° C.;
b) in a suitable solvent, combining, in a single or multiple steps, the thermally-treated layered double hydroxide, a methylaluminoxane and a compound having a structure according to formula (I) and/or formula (II) as defined in any preceding claim,
c) isolating the product resulting from step b).

21. The process of claim 20, wherein step b) comprises the sub-steps:
bi) contacting, in a first solvent, the thermally-treated layered double hydroxide and the methylaluminoxane (optionally under sonication), and
bii) contacting, in a second solvent, the product resulting from step b)i) with the compound of formula (I) and/or formula (II).

22. The process of claim 21, wherein the first and second solvents are identical or different.

23. The process of claim 21 or 22, wherein the first and second solvents are independently selected from toluene, hexane, benzene, pentane and a mixture of two or more thereof.

24. The process of any one of claim 21, 22 or 23, wherein any one or more of the sub-steps of step b) is conducted at a temperature of 18-120° C.

25. The process of claim 24, wherein any one or more of the sub-steps of step b) is conducted at a temperature of 50-100° C.

26. The process of any one of claims 20 to 25, wherein the amount of MAO used in step b) is 30-70 wt % based on the mass of the layered double hydroxide pre-thermal treatment.

27. The process of any one of claims 20 to 26, wherein the amount of MAO used in step b) is 35-45 wt % based on the mass of the layered double hydroxide pre-thermal treatment.

28. The process of any one of claims 20 to 27, wherein the amount of the compound of formula (I) and/or formula (II) used in step b) is 0.1-12.0 mol % relative to the number of moles of aluminium in the methylaluminoxane.

29. The process of any one of claims 20 to 28, wherein the amount of the compound of formula (I) and/or formula (II) used in step b) is 0.1-7.5 mol % relative to the number of moles of aluminium in the methylaluminoxane.

30. The process of any one of claims 20 to 29, wherein step a) comprises thermally treating a layered double hydroxide at a temperature of 120-200° C.

31. A solid support material obtainable by the process of any one of claims 20 to 30.

32. A catalytic composition comprising an olefin polymerisation catalyst supported on a solid support material as defined in any one of claims 1 to 10 and 31.

33. The catalytic composition of claim 32, wherein the olefin polymerisation catalyst has any of the structures shown below:

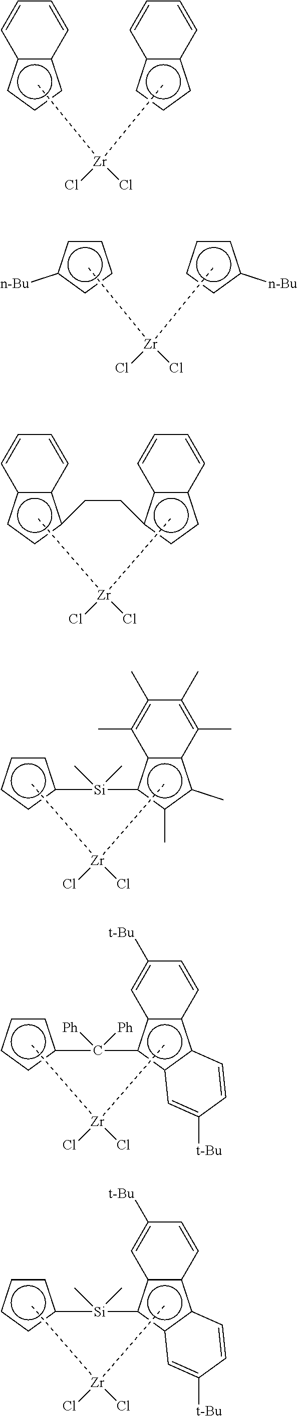

34. The catalytic composition of claim 32 or 33, wherein the olefin polymerisation catalyst has any of the structures shown below:

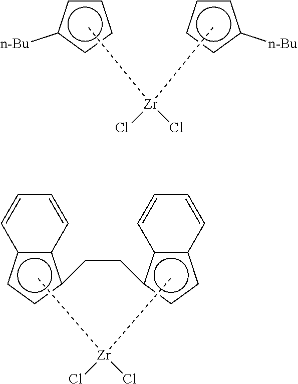

35. The catalytic composition of claim 33 or 34, wherein [Al_{MAO}]/[Zr] (i.e. the number of moles of Al in the methylaluminoxane of the solid support material divided by the number of moles of Zr in the olefin polymerisation catalyst) is 50-250.

36. The catalytic composition of claim 35, wherein [Al_{MAO}]/[Zr] is 75-225.

37. A process for the preparation of a polyolefin, the process comprising the step of:
a) contacting olefin monomers with a catalytic composition as defined in any one of claims 32 to 36.

38. The process of claim 37, wherein the polyolefin is polyethylene and the olefin monomers are ethene molecules.
